(19) United States
(12) Patent Application Publication
(10) Pub. No.: US 2026/0168490 A1
(43) Pub. Date: Jun. 18, 2026

(54) HIGH PERFORMANCE SEALING ASSEMBLY

(71) Applicant: Vulcan Industrial Holdings, LLC, Houston, TX (US)

(72) Inventors: Neerav Verma, Houston, TX (US); Benjamin Scott Berryhill, Houston, TX (US); Steven Zachary Newberg, Houston, TX (US); Joshua Dearman, Houston, TX (US); Richard David Peer, Houston, TX (US)

(21) Appl. No.: 19/326,300

(22) Filed: Sep. 11, 2025

Related U.S. Application Data
(60) Provisional application No. 63/694,645, filed on Sep. 13, 2024.
(60) Provisional application No. 63/774,172, filed on Mar. 19, 2025.
(60) Provisional application No. 63/854,411, filed on Jul. 30, 2025.

(51) Int. Cl. F04B 53/08; F04B 19/04; F04B 19/22

(52) U.S. Cl. CPC F04B 53/08; F04B 19/04; F04B 19/22

(57) ABSTRACT

A high performance sealing assembly may be positioned along a plunger bore for pumps such as high-pressure reciprocating pumps having a housing with one or more plunger bores defined therein and through which a plunger reciprocates. The sealing assembly may include a series of sealing elements. One or more of the sealing elements may include a base material combined with a thermally conductive material, a low coefficient of friction material, or a combination of both, so as to facilitate dissipation of heat generated by the reciprocation of the plunger through the sealing assembly, and/or facilitate a reduction in heat generated by such reciprocating movement of the plunger.

### CROSS REFERENCE TO RELATED APPLICATIONS

This application claims benefit of U.S. Provisional Application No. 63/854,411, filed Jul. 30, 2025, titled “HIGH PERFORMANCE SEALING ASSEMBLY,” U.S. Provisional Application No. 63/774,172, filed Mar. 19, 2025, titled “HIGH PERFORMANCE SEALING ASSEMBLY,” and U.S. Provisional Application No. 63/694,645, filed Sep. 13, 2024, titled “HIGH PERFORMANCE SEALING ASSEMBLY,” the disclosures of which are incorporated herein by reference in their entirety.

### TECHNICAL FIELD

The present disclosure generally relates to sealing assemblies, pumps and other fluid transfer equipment. In particular, the present disclosure is directed to a high performance sealing assembly for forming a packing seal for pumps, such as used in oil and gas drilling and fracturing operations, which is configured with enhanced thermal conductivity so as to extend the operational life of the packing seal and the components thereof.

### BACKGROUND

Pumping systems may be used in a variety of applications, including industrial applications where pumping systems are used to elevate a working fluid pressure. One such application is hydraulic fracturing systems, which use high pressure pumps to increase the fluid pressure of a working fluid (e.g., fracturing fluid, slurry, etc.) for injection into an underground formation. Such pumps may include a series of reciprocating plungers or pistons each moving through a pump housing along a fluid end packing bore to deliver the working fluid under high operating pressures. A packing seal generally may be provided along each packing or plunger bore to provide a sealing surface between the plunger and the pump housing. Such packing seals typically are subjected to wear from the contact between the seal elements and the plunger as the plunger reciprocates therethrough, as well as being subjected to high surface temperatures due to friction between the contacting surfaces of the plunger and the seal elements. Such high surface temperatures, in addition to engagement and wearing due to sliding movement of the plunger therealong may increase the rate at which the seal elements wear and degrade, shortening the working life of the packing seal assembly.

Accordingly, it may be seen that a need exists for sealing assemblies, seal constructions, and components thereof, and related methods configured to address the foregoing and other related and unrelated problems in the art.

### SUMMARY

Briefly described, the present disclosure is directed to sealing assemblies for pumping systems. In embodiments, the present disclosure is directed to a high performance sealing assembly for pumping systems, including high-power pumps such as used in the oil and gas industry, and other applications where the operating conditions and fluids may present a particularly harsh environment. In some embodiments, the sealing systems, assemblies, apparatuses, and methods presented herein may provide a high performance sealing assembly adapted to provide an enhanced fluid seal between components of a pump, such as between a plunger and a portion of a pump housing or other component. The high performance sealing assembly, in embodiments, may comprise a packing seal assembly and adjacent components, and which may be configured to reduce or prevent damage, deformation, wear, and/or leakage of the packing seal assembly and associated components during operation of a pumping system, including high-power pumps.

By way of example, in some embodiments, the high performance sealing assembly may comprise a packing seal assembly configured for providing a fluid seal between a first surface and a second surface of the pump, e.g., in embodiments, between an outer surface of a piston or plunger and a surface of a pump housing, e.g. a surface alone, a plunger bore or a packing sleeve received along the plunger bore within the pump housing and through which the plunger is reciprocated. In embodiments, the high performance sealing assembly may be utilized in various types of fluid pumping systems, including pumps such as positive displacement reciprocating pumps or other high-power pumps that may include one or more pistons or plungers.

In an example embodiment, the high performance sealing assembly may be utilized in a fluid pumping system, for example, a high-power pump such as a hydraulic fracturing pump having a fluid end and a power end. In embodiments, the fluid end may include a housing that may be configured with one or more plunger bores defined therein, each plunger bore extending through the housing and toward a fluid chamber. A plunger or piston generally will be received within each plunger bore and will be driven in a reciprocating motion within its plunger bore for driving a fluid under pressure through the pump from an intake to a discharge. During operation of the pump, each plunger will reciprocate within/along its plunger bore, moving in a first direction to allow a lower pressure fluid to flow into the fluid chamber, and then in a second, opposing direction, reducing the volume of the fluid chamber and causing the fluid to be discharged from the fluid chamber under higher pressure.

In embodiments, each plunger bore may define an annular space around the plunger of its plunger assembly. In embodiments, a packing sleeve may be received within the annular space defined along the plunger bore, being positioned between the plunger (e.g., a first component) and a portion of the pump housing (e.g., a second component) and along the plunger bore. In embodiments, the high performance sealing assembly generally will be configured to be received within the annular space, positioned between the outer surface of the plunger and a surface of the packing sleeve and extending along at least a portion of the plunger bore. In other embodiments, a packing sleeve may not be used. In addition, in embodiments, a first annular ring, generally comprising a ring seal (e.g., a pressure ring) and a second or adjacent annular ring, which may generally comprise a ring seal, may be positioned along the plunger bore, and with each of the first and second annular seals being engaged with the pump housing and including a circular bore formed therethrough.

In embodiments, the first and second annular seals may be located at opposite ends of the annular space defined along the plunger bore and around the plunger, with the packing sleeve positioned within the annular space between the first and second annular rings. In embodiments, the high performance sealing assembly may comprise a packing sleeve assembly that may be received/positioned between an outer surface of the plunger and an inner surface of the packing sleeve so as to create a seal the between the surface of the plunger and a surface of the packing sleeve and thus the pump housing. In addition, in embodiments, a packing nut may extend into the plunger bore and may connect, via a threaded interface, to the second annular seal. In embodiments, the packing nut may be configured to axially anchor the packing seal elements of the high performance sealing assembly within the annular space around the plunger. The packing nut further may axially compress the high performance sealing assembly, depending on the extent to which the packing nut is threaded into the plunger bore via the threaded interface with the second annular seal.

According to some embodiments, the high performance sealing assembly will be configured to enhance a fluid seal between a surface of a first component of a pump and a surface of a second component of the pump, and further may comprise a packing seal assembly adapted to be positioned within and extend along at least a portion of a plunger bore of a fluid end of the pump. In embodiments, the high performance sealing assembly may include a series of components or seal elements, which, in some embodiments, may include one or more of: (a) a lantern ring; (b) a lube seal; (c) an adaptor ring; (d) a pressure ring; (e) a header ring; (f) a junk ring; or combinations thereof.

In embodiments, the seal elements may be arranged and/or stacked in series to define an annular seal body having an internal passage or bore defined therethrough and through which the first component of a pump, e.g., a plunger is received and moves. The seal body of the high performance sealing assembly may be positioned between the first and second components (e.g. the plunger and a portion of the pump housing or component thereof such as a packing sleeve, and further will include an outer or second surface configured to contact a surface of the high performance sealing assembly, with a surface of the second component (e.g., a packing sleeve or a portion of the pump housing), and a second or inner surface defining a body sealing surface about the bore.

In embodiments, one or more of the seal elements will be configured to provide enhanced thermal conductivity though one or more components thereof to facilitate dissipation of heat generated by a reciprocating motion of the plunger through the high performance sealing assembly. For example, in some embodiments, the annular seal body, or at least some of the components thereof, may include a first or base component of a first material, and a second component. In embodiments, the second component may comprise one or more additive components, including at least one thermally conductive material configured to enhance thermal conductivity between the high performance sealing assembly and one or more of a first component or a second component of the pump, so as to transfer heat from the packing seal to one or more of the first component or the second component.

In various embodiments, one or more components of the seal elements may comprise a thermally conductive material or materials, having a thermal conductivity that is greater than a thermal conductivity of a base material of the sealing element(s), selected to provide increased thermal conductivity without creating additional friction between the plunger of the pump and the high performance sealing assembly. For example, in embodiments, the header ring and/or other seal elements such as the lantern rings may comprise a metal or metal alloy, and in some embodiments, may include a metal mesh (which may include a woven or non-woven mesh of fabric), sleeve, fibers, strips, ribbons, filaments, chips, or combinations thereof, to provide enhanced thermal conductivity between the header ring and one or more of the first component or the second component for transfer heat from the header ring and/or lantern rings to one or more of the first component or the second component, thereby to reduce a temperature of the high performance sealing assembly and extend a service life thereof.

In embodiments, one or more of the seal elements may comprise various mixtures of materials that may include one or more first or base materials having a selected wear resistance and chemical resistance to debris and contaminants within the fluid flowing through the fluid end (e.g., in embodiments, including a polymer material) that may be combined with materials having a higher thermal conductivity. In addition, or alternatively, in some embodiments, one or more of the seal elements may comprise one or more second materials (e.g., including various additive materials) having a lower coefficient of friction than that of the base material(s), and configured to reduce friction between an outer surface of the plunger and inner surfaces of one or more of the seal elements, and which, in embodiments, may be combined with materials having a selected wear resistance and chemical resistance, materials having a higher thermal conductivity, or combinations thereof.

Still further, in embodiments, one or more of the seal elements may comprise a combination of additive components including materials having an increased or higher thermal conductivity that is greater than the thermal conductivity of the base material and which may be coated, plated or otherwise combined with a low coefficient of friction material having a lower coefficient of friction than the base material along an inner surface thereof. The seal elements may thus be provided or formed with a reduced friction layer or surface along an inner surface thereof, which may help reduce friction between the plunger and the seal elements as the plunger is reciprocated therethrough, while also having an increased thermal conductivity to increase dissipation of heat generated by the reciprocation of the plunger.

According to another aspect, a high-pressure reciprocating pump may include a housing and at least one plunger assembly including a plunger received within a plunger bore extending through the housing and configured to move in a reciprocating motion along the plunger bore for pumping a fluid through a fluid chamber. The high-pressure reciprocating pump further may include a sealing assembly including a plurality of seal elements. At least one seal element of the plurality of seal elements may include at least one component positioned to increase dissipation of heat due to movement along the plunger bore in contact with the sealing assembly. The at least one component may include a first component including a first material having a thermal conductivity and a coefficient of friction. The at least one component further may include a second component including one or more of (a) a thermally conductive material having a thermal conductivity greater than the thermal conductivity of the first component or (b) a low coefficient of friction material having a coefficient of friction lower than the coefficient of friction of the first material.

In embodiments, the at least one component comprises a first component comprising a first material, and a second component comprising a thermally conductive material having a thermal conductivity greater than a thermal conductivity of the first component, a low coefficient of friction material having a coefficient of friction lower than a coefficient of friction of the first material, or a combination thereof. In embodiments, at least one of the seal elements includes a thermally conductive reinforcing fabric and further comprises at least one of a pressure ring and a header ring.

In embodiments, the thermally conductive reinforcing fabric comprises: about 5% to about 100% carbon fiber; about 0% to about 95% of secondary fibers comprising aramid fibers, cotton fibers, PET fibers, or combinations thereof; and about 0% to about 95% of a binder comprising: urethane, elastomers, thermoplastics, rubber, or combinations thereof.

In embodiments, the thermally conductive reinforcing fabric includes carbon fiber and a binder; and wherein the binder comprises an elastomer, urethane, thermoplastic rubber, fiber reinforced rubber, PTFE, or combinations thereof.

In embodiments, the at least one pressure ring and the at least one header ring further comprises a core wrapped with the thermally conductive reinforcing fabric.

In embodiments, the plunger bore includes a packing recess defined therealong, and a packing sleeve positioned along the packing recess between the sealing assembly and the housing.

In embodiments, the at least one plunger includes a coating; and wherein the coating comprises a thermally conductive material, a reduced friction material or a combination thereof. In embodiments, the at least one plunger further comprising a power end coupled to the housing and configured to transfer power for driving the reciprocating motion of the plunger along the plunger bore.

In embodiments, the at least one seal element further comprises a heat sink defined along at least a portion thereof.

In embodiments, the at least one seal element comprises a pressure ring or a header ring.

In embodiments, the first component of the at least one seal element comprises a binder material and the at least one additional component of the at least one seal element comprises a thermally conductive material including carbon fiber, and wherein the first component and the second component are combined to form a fabric material.

In embodiments, the fabric material is molded to form the at least one seal element.

In embodiments, the fabric material is applied as a wrapping about a core.

In embodiments, the binder material further comprises a thermally conductive additive or a friction modifying additive.

In embodiments, the thermally conductive additive or the friction modifying addition comprises PTFE, boron nitride, lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

According to another aspect, a high-pressure reciprocating pump may include a housing and at least one plunger assembly including a plunger received within a plunger bore extending through the housing and configured to move in a reciprocating motion along the plunger bore. The high-pressure reciprocating pump further may include a sealing assembly including a plurality of seal elements positioned along the plunger bore between the plunger and the housing. At one of the seal elements may include a first material having a thermal conductivity and a coefficient of friction, and a second material positioned to increase dissipation of heat due to movement along the plunger bore in contact with the sealing assembly. The second material may include a thermally conductive material having one or more of (a) a thermal conductivity greater than the thermal conductivity of the first material or (b) a low coefficient of friction material having a coefficient of friction lower than the coefficient of friction of the first material.

In embodiments, the second material comprises a thermally conductive material having a thermal conductivity greater than a thermal conductivity of the first material, or a low coefficient of friction material having a coefficient of friction lower than a coefficient of friction of the first material, or a combination thereof.

In embodiments, the thermally conductive material comprises boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

In some embodiments, the thermally conductive material comprises a thermally conductive reinforcing fabric.

In some embodiments, the thermally conductive material comprises a plurality of thermally conductive fibers including carbon fibers.

In embodiments, the first material comprises a binder comprising an elastomer, urethane, thermoplastic rubber, fiber reinforced rubber, or combinations thereof substantially mixed with the thermally conductive fibers; and wherein the at least one of the seal elements is molded from a mixture of the thermally conductive fibers and the binder.

In embodiments, the thermally conductive material comprises a plurality of fibers, flakes, filaments, a mesh, sheet material, strips, ribbons, chips, or combinations thereof, of a metal and/or metal alloy integrated with one or more of the seal elements, applied about one or more of the seal elements, or combinations thereof.

In embodiments, the one or more seal elements comprises at least one lantern ring, at least one adaptor ring, at least one pressure ring, and at least one header ring, arranged in a stacked configuration defining a seal body.

In embodiments, the one or more seal elements includes the at least one pressure ring, the at least one header ring, or a combination thereof, and wherein the second material comprises a thermally conductive material is configured to enhance thermal conductivity of the at least one pressure ring, the at least one header ring, or a combination thereof, so as to increase a transfer of heat generated by the reciprocating motion of the plunger along the plunger bore.

In embodiments, the first material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In embodiments, the pump further comprises a power end coupled to the housing and configured to transfer power for driving the reciprocating motion of the plunger along the plunger bore.

In embodiments, the pump further comprises a packing recess defined along the plunger bore and within which a packing sleeve is received; wherein the sealing assembly is positioned in contact with the packing sleeve.

In embodiments, the sealing assembly is configured to facilitate an increased transfer of heat due to the movement of the plunger along the plunger bore.

In embodiments, the pump further comprises a power end coupled to the housing and configured to drive the movement of the plunger along the plunger bore.

In embodiments, the pump comprises a hydraulic fracturing pump.

In embodiments, the first material comprises a polymeric material, and the second material comprises boron nitride, graphene, Silicon or SI-containing compounds, carbon nanotubes, Aluminum or Al-containing compounds, Copper or Cu-containing compounds or copper alloys, Zinc or Zn-containing compounds, brass, bronze, silver, silver alloys, steel, steel alloys, magnesium containing compounds, or a combination thereof.

In embodiments, the first material comprises a low coefficient of friction material, and the second material comprises a material with a high thermal conductivity that is greater than a thermal conductivity of the first material; and wherein the second material is integrated with the first material so as to provide the at least one of the seal elements with a total thermal conductivity that is greater than the thermal conductivity of the first material.

In embodiments, the at least one of the seal elements comprises a core; and wherein first material comprises a binder and the second comprises thermally conductive reinforcing fabric including a woven fabric, non-woven fabric, knit fabric, short fiber fabric, or combinations thereof, combined with the binder and wrapped about the core.

In some embodiments, the thermally conductive reinforcing fabric comprises: about 5% to about 100% carbon fiber; about 0% to about 95% of secondary fibers comprising aramid fibers, cotton fibers, PET fibers, or combinations thereof; and about 0% to about 95% of the binder.

In embodiments, the binder may comprise an elastomer, urethane, thermoplastic rubber, fiber reinforced rubber, or combinations thereof.

In embodiments, the core comprises an elastomer, urethane, thermoplastic rubber, fiber reinforced rubber, PTFE, or combinations thereof.

In embodiments, the at least one seal element further comprises a heat sink defined along at least a portion thereof.

In embodiments, the at least one of the one or more seal elements comprises at least one lantern ring, at least one adaptor ring, at least one pressure ring, and at least one header ring, arranged in a stacked configuration defining a seal body.

In embodiments, at least one of the at least one pressure ring and the at least one header ring comprises a thermally conductive reinforcing fabric including carbon fiber and a binder.

In some embodiments, the binder includes a thermally conductive additive, a friction modifying additive, or a combination thereof.

In some embodiments, the thermally conductive additive or the friction modifying additive may comprise PTFE, boron nitrate, Lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

According to other aspects, a high-pressure reciprocating pump may include at least one plunger assembly including a plunger received within a plunger bore and configured to move in a reciprocating motion along the plunger bore. The high-pressure reciprocating pump further may include a sealing assembly including a plurality of seal elements positioned along the plunger bore between the plunger and an additional component of the pump. At least one seal element of the plurality of seal elements may include a first component having a thermal conductivity and a coefficient of friction, and a second component configured to increase dissipation of heat due to movement along the plunger bore in contact with the sealing assembly. The second component may include one or more of (a) a thermally conductive material having a thermal conductivity greater than the thermal conductivity of the first component or (b) a low coefficient of friction material having a coefficient of friction lower than the coefficient of friction of the first component, so as to facilitate increased transfer of heat from the sealing assembly to one or more of a first component of the high-pressure reciprocating pump or a second component of the high-pressure reciprocating pump.

In embodiments, the at least one second component may comprise a thermally conductive material having a thermal conductivity greater than a thermal conductivity of the first component, or a low coefficient of friction material having a coefficient of friction lower than a coefficient of friction of the first component, or a combination thereof, so as to facilitate increased transfer of heat from the sealing assembly to one or more of a first component or a second component of the pump.

In embodiments, the first component may comprise an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In embodiments, the second component may comprise a thermally conductive material including boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

In some embodiments, the first component comprises a core, and the second component comprises thermally conductive reinforcing fabric wrapped about an outer surface of the core.

In some embodiments, the thermally conductive reinforcing fabric may comprise a woven, non-woven, knit, short fiber, or combinations thereof.

In some embodiments, the thermally conductive reinforcing fabric comprises: a plurality of fibers including: about 5% to about 100% of a primary fiber comprising carbon fiber; and about 0% to about 95% of one or more secondary fibers; and a binder.

In embodiments, the binder may comprise urethane, elastomers, thermoplastics, rubber, or combinations thereof.

In embodiments, the binder further may comprise a thermal conductivity additive or friction modifying additive including: magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

In embodiments, the one or more secondary fibers may comprise aramid fibers, cotton fibers, PET fibers, or combinations thereof.

In embodiments, the first component comprises a low coefficient of friction material comprising PTFE or PTFE-containing compounds, graphene or graphene-containing compounds, MoS₂ or MoS₂-containing compounds, or combinations thereof.

In embodiments, the second component comprises a thermally conductive material including carbon fibers and one or more additional thermally conductive materials including aramid fibers, cotton fibers, PET fibers, nitride, graphene, Silicon or SI-containing compounds, carbon nanotubes, magnesium containing compounds, metal or metal alloys, or a combination thereof.

In some embodiments, the metal or metal alloy materials comprise one or more of aluminum, aluminum alloy, brass, bronze, silver, silver alloy, copper, copper alloy, steel, steel alloy, or a combination thereof.

In some embodiments, the metal or metal alloy comprises a plurality of metal and/or metal alloy fibers, including loose metalized fibers, metal and/or metal alloy flakes, metal and/or metal alloy filaments, a metal and/or metal alloy mesh, metal and/or metal alloy sheet materials including metalized fabrics or ribbons, a woven metal and/or metal alloy mesh, metal and/or metal alloy chips, or combinations thereof.

In embodiments, the second component comprises a thermally conductive material; and wherein the first component of the at least one seal element is substantially integrated or mixed with the thermally conductive material to form a seal element with a thermal conductivity greater than 0.5 W/mK.

In embodiments, the plurality of seal elements comprises at least one lantern ring; at least one lube seal; at least one adaptor ring; at least one pressure ring; and at least one header ring.

In embodiments, the at least one seal element further comprises a heat sink defined along at least a portion thereof.

In embodiments, the at least one seal element comprises a pressure ring or a header ring.

In embodiments, the first component of the at least one seal element may comprise a binder material and the second component of the at least one seal element comprises a thermally conductive material including carbon fiber, and wherein the first component and the second component are combined to form a thermally conductive reinforcing fabric material.

In some embodiments, the thermally conductive reinforcing fabric material is molded to form the at least one seal element.

In some embodiments, the thermally conductive reinforcing fabric material is applied as a wrapping about a core.

In embodiments, the binder material may further comprise a thermally conductive additive or a friction modifying additive.

In some embodiments, the thermally conductive additive or the friction modifying additive comprises PTFE, boron nitrate, Lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

In embodiments, the first component of the at least one seal element comprises a core, and the second component of the at least one seal element comprises a thermally conductive material including carbon fiber and a binder; and wherein the thermally conductive material including carbon fiber and the binder are substantially mixed to form a thermally conductive reinforcing fabric material and applied as a wrapping about the core.

In some embodiments, the plunger includes a plunger coating to a surface of the plunger applied thereto; and wherein the plunger coating includes a filler material comprising a high thermal conductivity material.

In some embodiments, the high thermal conductivity material of the plunger coating may comprise boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

In embodiments, the pump further comprises a power end coupled to the housing and configured to transfer power for driving the reciprocating motion of the plunger along the plunger bore.

In embodiments, the pump further comprises a packing recess defined along the plunger bore and within which a packing sleeve is received; wherein the sealing assembly is positioned in contact with the packing sleeve.

In embodiments, the pump further comprises the pump comprises a hydraulic fracturing pump.

According to some aspects of the present disclosure, a sealing assembly for a high-pressure reciprocating pump may include a plurality of seal elements arranged in series to define an annular seal body having an outer surface. At least one seal element of the plurality of seal elements may include (a) a first component including one or more of a wear resistant material or a low coefficient of friction material, and (b) at least one additional component substantially integrated with the first component. The at least one additional component may include one or more of (1) a thermally conductive material having a thermal conductivity greater than a thermal conductivity of the first component, or (2) a low coefficient of friction material having a coefficient of friction lower than a coefficient of friction of the first component, so as to facilitate increased transfer of heat from the sealing assembly to one or more of a first component or a second component of a pump.

In embodiments of the sealing assembly, the first component may comprise a core, and the at least one additional component may comprise thermally conductive reinforcing fabric applied about an outer surface of the core.

In some embodiments of the sealing assembly, the thermally conductive reinforcing fabric may comprise a woven, non-woven, knit, short fiber, or combinations thereof.

In embodiments of the sealing assembly, the thermally conductive reinforcing fabric comprises: a plurality of fibers including: about 5% to about 100% of a primary fiber comprising carbon fiber; and about 0% to about 95% of one or more secondary fibers; and a binder.

In embodiments of the sealing assembly, the binder may comprise urethane, elastomers, thermoplastics, rubber, or combinations thereof.

In some embodiments of the sealing assembly, binder further comprises a thermal conductivity additive or a friction modifying additive including: magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

In embodiments of the sealing assembly, the one or more secondary fibers may comprise aramid fibers, cotton fibers, PET fibers, or combinations thereof. The at least one seal element further may comprise a heat sink defined along at least a portion thereof.

In embodiments of the sealing assembly, the at least one seal element comprises a pressure ring or a header ring.

In embodiments of the sealing assembly, the first component of the at least one seal element comprises a binder material and the at least one additional component of the at least one seal element comprises a thermally conductive material including carbon fiber, and wherein the first component and the second component are combined to form a fabric material.

In some embodiments of the sealing assembly, the fabric material is molded to form the at least one seal element.

In some embodiments of the sealing assembly, the fabric material is applied as a wrapping about a core.

In some embodiments of the sealing assembly, the binder material further comprises a thermally conductive additive or a friction modifying additive.

In embodiments of the sealing assembly, the thermally conductive additive or friction modifying additive may comprise PTFE, boron nitride, lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

According to additional aspects, a sealing assembly for a high-pressure reciprocating pump may include a plurality of seal elements arranged in series, so as to define an annular seal body having an outer surface. At least one seal element of the plurality of seal elements may include a first component having a thermal conductivity and a coefficient of friction, and at least one additional component positioned to increase a transfer of heat generated by a reciprocating motion of a plunger of the pump along the plunger bore to one or more of a packing sleeve, a plunger, a housing, or a fluid passing through the plunger bore. The at least one additional component may include one or more of (a) a thermally conductive material having a thermal conductivity greater than the thermal conductivity of the first component or (b) a low coefficient of friction material having a coefficient of friction lower than the coefficient of friction of the first component, so as to facilitate increased transfer of heat from the sealing assembly to one or more of a first component of the high-pressure reciprocating or a second component of the high-pressure reciprocating pump.

In embodiments, the at least one additional component may comprise a thermally conductive material having a thermal conductivity greater than a thermal conductivity of the first component, or a low coefficient of friction material having a coefficient of friction lower than a coefficient of friction of the first component, or a combination thereof, so as to facilitate increased transfer of heat from the sealing assembly to one or more of a first component or a second component of the pump.

In embodiments, the first component may comprise an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In embodiments, the at least one additional component may comprise a thermally conductive material including boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

In embodiments, the first component comprises a core, and the at least one additional component comprises thermally conductive reinforcing fabric wrapped about an outer surface of the core.

In some embodiments, the thermally conductive reinforcing fabric comprises a woven, non-woven, knit, short fiber, or combinations thereof.

In embodiments, the thermally conductive reinforcing fabric may comprise: a plurality of fibers including: about 5% to about 100% of a primary fiber comprising carbon fiber; and about 0% to about 95% of one or more secondary fibers; and a binder.

In some embodiments, the binder may comprise urethane, elastomers, thermoplastics, rubber, or combinations thereof.

In some embodiments, the binder may further comprise a thermal conductivity additive or friction modifying additive including: magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

In some embodiments, the one or more secondary fibers comprise aramid fibers, cotton fibers, PET fibers, or combinations thereof.

In embodiments, the first component comprises a low coefficient of friction material comprising PTFE or PTFE-containing compounds, graphene or graphene-containing compounds, MoS₂ or MoS₂-containing compounds, or combinations thereof.

In some embodiments, the second component comprises a thermally conductive material including carbon fibers and one or more additional thermally conductive materials including aramid fibers, cotton fibers, PET fibers, nitride, graphene, Silicon or SI-containing compounds, carbon nanotubes, magnesium containing compounds, metal or metal alloys, or a combination thereof.

In some embodiments, wherein the metal or metal alloy materials comprise one or more of aluminum, aluminum alloy, brass, bronze, silver, silver alloy, copper, copper alloy, steel, steel alloy, or a combination thereof.

In some embodiments, wherein the metal or metal alloy comprises a plurality of metal and/or metal alloy fibers, including loose metalized fibers, metal and/or metal alloy flakes, metal and/or metal alloy filaments, a metal and/or metal alloy mesh, metal and/or metal alloy sheet materials including metalized fabrics or ribbons, a woven metal and/or metal alloy mesh, metal and/or metal alloy chips, or combinations thereof.

In embodiments, the at least one additional component comprises a thermally conductive material; and wherein the first component of the at least one seal element is substantially integrated or mixed with the thermally conductive material to form a seal element with a thermal conductivity greater than 0.5 W/mK.

In embodiments, the plurality of seal elements comprises at least one lantern ring; at least one lube seal; at least one adaptor ring; at least one pressure ring; and at least one header ring.

In embodiments, the at least one seal element further comprises a heat sink defined along at least a portion thereof.

In embodiments, the at least one seal element comprises a pressure ring or a header ring.

In embodiments, the first component of the at least one seal element comprises a binder material and the at least one additional component of the at least one seal element comprises a thermally conductive material including carbon fiber, and wherein the first component and the second component are combined to form a thermally conductive reinforcing fabric material.

In some embodiments, the thermally conductive reinforcing fabric material is molded to form the at least one seal element.

In some embodiments, the thermally conductive reinforcing fabric material is applied as a wrapping about a core.

In some embodiments, the binder material further comprises a thermally conductive additive or a friction modifying additive.

In embodiments, wherein the first component of the at least one seal element may comprise a core, and the at least one additional component of the at least one seal element comprises a thermally conductive material including carbon fiber and a binder; and wherein the thermally conductive material including carbon fiber and the binder are substantially mixed to form a thermally conductive reinforcing fabric material and applied as a wrapping about the core.

According to another aspect of the present disclosure, a method for enhancing a seal between a first component of a pump and a second component of the pump may include positioning a sealing assembly between a surface of the first component of the pump and a surface of the second component of the pump. The sealing assembly may include a seal body having plurality of seal elements. At least one seal element may include a base component including (1) one or more of a wear resistant material or a low coefficient of friction material, and (2) at least one additive component substantially integrated therewith. The at least one seal element further may include one or more of (a) a thermally conductive material having one or more of a thermal conductivity greater than a thermal conductivity of a base material of the at least one seal element, or (b) a low coefficient of friction material having a coefficient of friction lower than a coefficient of friction of the base material. The method further may include transferring heat, generated by movement of the first component of the pump with respect to the second component of the pump, through the seal body of the sealing assembly to one or more of: (a) the first component of the pump, (b) the second component of the pump, or (c) a fluid passing through the pump, thereby to reduce a temperature of the seal and extend a service life of the seal.

In embodiments, the plurality of seal elements are positioned in a stacked arrangement to define the seal body; and wherein transferring of heat, through the seal body to the first component, to the second component, to a fluid passing through the pump, or a combination thereof, comprises transferring heat from the seal body to one or more of a packing sleeve, a fluid end block, a plunger, a portion of a housing, or combinations thereof.

In embodiments, the positioning the sealing assembly comprises positioning one or more of the seal elements of the seal assembly between a stationary component of the pump and one of (a) a reciprocating component of the pump or (b) a rotating component of the pump.

In embodiments, the base component may comprise an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In embodiments, positioning the sealing assembly comprises positioning the seal between a stationary component of the pump and one of (a) a reciprocating component of the pump or (b) a rotating component of the pump.

In embodiments, positioning the sealing assembly comprises positioning the sealing assembly along a plunger bore between a packing sleeve of the pump and a plunger of the pump.

In some embodiments of the method, the at least one seal element further comprises: a base material comprising a wear resistant material, a low coefficient of friction material, or a combination thereof; and at least one additive material substantially integrated therewith; and wherein the at least one additive material comprises: a thermally conductive material having a thermal conductivity greater than a thermal conductivity of a base material of the at least one seal element; a low coefficient of friction material having a coefficient of friction lower than a coefficient of friction of the base material; or a combination thereof.

In some embodiments of the method, the base material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In some embodiments of the method, the at least one additive material comprises a thermally conductive reinforcing fabric including: about 5% to about 100% carbon fiber; about 0% to about 95% of secondary fibers comprising aramid fibers, cotton fibers, PET fibers, or combinations thereof; and about 0% to about 95% of a binder comprising: urethane, elastomers, thermoplastics, rubber, or combinations thereof.

In embodiments, the thermally conductive reinforcing fabric further may comprise aramid fibers, cotton fibers, PET fibers, or combinations thereof.

In embodiments, the plunger may include a plunger coating to a surface of the plunger applied thereto; and wherein the plunger coating includes a filler material comprising a high thermal conductivity material.

In embodiments, the high thermal conductivity material of the plunger coating comprises boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

According to another aspect of the present disclosure, a method for enhancing a seal between a first component of a high-pressure reciprocating pump and a second component of the high-pressure reciprocating pump may include positioning a sealing assembly between a surface of the first component of the high pressure reciprocating pump and a surface of the second component of the high pressure reciprocating pump. The sealing assembly may include a seal body including plurality of seal elements. At least one seal element of the plurality of seal elements may include a thermally conductive material. The method further may include transferring heat, generated by movement of the first component of the high-pressure reciprocating pump with respect to the second component of the high-pressure reciprocating pump, through the seal body of the sealing assembly to one or more of (a) the first component, (b) the second component, or (c) a fluid passing through the high-pressure reciprocating pump, thereby to reduce a temperature of the seal and extend a service life of the seal.

In embodiments, the plurality of seal elements are positioned in a stacked arrangement to define the seal body; and wherein transferring of heat, through the seal body to the first component, to the second component, to a fluid passing through the pump, or a combination thereof, comprises transferring heat from the seal body to one or more of a packing sleeve, a fluid end block, a plunger, a portion of a housing, or combinations thereof.

In embodiments, the positioning the sealing assembly comprises positioning one or more of the seal elements of the seal assembly between a stationary component of the pump and one of (a) a reciprocating component of the pump or (b) a rotating component of the pump.

In embodiments, the base component may comprise an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In embodiments, positioning the sealing assembly comprises positioning the seal between a stationary component of the pump and one of (a) a reciprocating component of the pump or (b) a rotating component of the pump.

In embodiments, positioning the sealing assembly comprises positioning the sealing assembly along a plunger bore between a packing sleeve of the pump and a plunger of the pump.

In some embodiments of the method, the at least one seal element further comprises: a base material comprising a wear resistant material, a low coefficient of friction material, or a combination thereof; and at least one additive material substantially integrated therewith; and wherein the at least one additive material comprises: a thermally conductive material having a thermal conductivity greater than a thermal conductivity of a base material of the at least one seal element; a low coefficient of friction material having a coefficient of friction lower than a coefficient of friction of the base material; or a combination thereof.

In some embodiments of the method, the base material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON™, polyurethane, or combinations thereof.

In some embodiments of the method, the at least one additive material comprises a thermally conductive reinforcing fabric including: about 5% to about 100% carbon fiber; about 0% to about 95% of secondary fibers comprising aramid fibers, cotton fibers, PET fibers, or combinations thereof; and about 0% to about 95% of a binder comprising: urethane, elastomers, thermoplastics, rubber, or combinations thereof.

In embodiments, the thermally conductive reinforcing fabric further may comprise aramid fibers, cotton fibers, PET fibers, or combinations thereof.

In embodiments, the plunger may include a plunger coating to a surface of the plunger applied thereto; and wherein the plunger coating includes a filler material comprising a high thermal conductivity material.

In embodiments, the high thermal conductivity material of the plunger coating comprises boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

Accordingly, embodiments of pumps and sealing assemblies for pumps, including a high performance sealing assembly for sealing an area between a plunger of a pump and a side wall of a bore of a pump housing through which the plunger is reciprocated, which are configured to provide a reduction in heat acting on the high performance sealing assembly, including providing the sealing assemblies with enhanced thermal conductivity for increased dissipation of heat generated by reciprocation of the plunger, and/or a reduction in friction between the plunger and the elements of the high performance sealing assembly, and which are directed to the above-discussed and other needs, are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

The accompanying drawings, which are included to provide a further understanding of the embodiments of the present disclosure, are incorporated in and constitute a part of this specification, illustrate embodiments of this disclosure, and together with the detailed description, serve to explain the principles of the embodiments discussed herein. No attempt is made to show structural details of this disclosure in more detail than may be necessary for a fundamental understanding of the exemplary embodiments discussed herein and the various ways in which they may be practiced.

The present technology will be better understood on reading the following detailed description of non-limiting embodiments thereof, and on examining the accompanying drawings, in which:

FIG. 1A is a side view, with portions exploded, of a fluid end of a hydraulic pump.

FIG. 1B is a perspective view of a fluid end of a hydraulic pump such as shown in FIG. 1A.

FIG. 2A is a cross-sectional view of a plunger assembly of a fluid end of a hydraulic pump such as illustrated in FIGS. 1A-1B, incorporating a high performance sealing assembly as a packing seal positioned along a plunger bore of the plunger, in accordance with the principles of the present disclosure.

FIG. 2B is a schematic side sectional view of a portion of the example plunger assembly of a fluid end of a hydraulic pump shown in FIG. 2A, showing an embodiment of the high performance sealing assembly positioned within a packing recess along the plunger bore, in accordance with the principles of the present disclosure.

FIG. 3A is a perspective view of an example embodiment of a high performance sealing assembly in accordance with the principles of the present disclosure.

FIG. 3B is a side sectional view of the high performance sealing assembly of FIG. 3A.

FIG. 4 is an exploded perspective view of an example embodiment of a high performance sealing assembly in accordance with the principles of the present disclosure.

FIG. 5 is a side sectional view of another example embodiment of a performance sealing assembly in accordance with the principles of the present disclosure.

FIG. 6A is a side view illustrating an example embodiment of a seal element of a sealing assembly including a thermally conductive reinforcing fabric in accordance with the principles of the present disclosure.

FIG. 6B is a side view illustrating an example embodiment of a seal element of a sealing assembly including a thermally conductive reinforcing fabric wrapped about a core in accordance with the principles of the present disclosure.

FIG. 6C a schematic partial section view of another example embodiment of a seal element of a packing assembly seal in accordance with the principles of the present disclosure.

FIG. 7A is a perspective view showing a seal element of a sealing assembly including a heat sink defined along a portion thereof in accordance with the principles of the present disclosure.

FIG. 7B is a side sectional view of a portion of a seal element with a heat sink defined therealong, such as shown in FIG. 7A.

FIG. 7C is a side sectional view of portion of an additional embodiment of a seal element having a heat sink defined therealong in accordance with the principles of the present disclosure.

### DETAILED DESCRIPTION

Embodiments of the present disclosure will now be described in more detail with reference to the attached drawing figures. It will be understood that the following description in combination with the Figures is provided to assist in understanding the embodiments and principles disclosed herein, and should not be interpreted as a limitation on the scope or applicability thereof.

As used herein, the terms “comprises,” “comprising,” “includes,” “including,” “has,” “having,” or any other variation thereof, and are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or.

Dimensional information in the following description should be understood as nominal dimensions that are intended to encompass variations in dimensions that normally occur in the commercial production of laminated asphalt composition roofing shingles. Terms such as “approximately,” “about,” and “substantially” may be used to qualify dimensional information in the following description but such qualifications are intended merely to reinforce that the dimensions are nominal dimensions and not to differentiate qualified dimensions from unqualified dimensions.

The terminology used herein is for the purpose of description only and is not intended to be limiting of the present disclosure. Spatially relative terms, such as “beneath,” “below,” “lower,” “above,” “upper,” and the like may be used herein for ease of description to describe one element's or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” may encompass both an orientation of above and below. The device may be otherwise oriented (e.g., rotated 90 degrees or at other orientations) and the spatially relative descriptors used herein interpreted accordingly.

As used herein, the singular forms “a,” “an,” and “the” are intended to include the plural forms as well, unless the context indicates otherwise. It will be further understood that the terms “comprises” and/or “comprising” specify the presence of stated features, steps, operations, elements, and/or components, but do not preclude the presence or addition of one or more other features, steps, operations, elements, components, and/or groups thereof.

Embodiments of the present disclosure are directed to sealing assemblies for pumps, and in particular, to a high performance sealing assembly for providing an enhanced seal between components of a pump, such as between an outer side wall of a plunger and a wall of a plunger bore extending through a pump housing of a pump and along which the plunger is reciprocated. The term “pump” may include a variety of pumps such as such as a positive displacement reciprocating pump, including hydraulic fracturing pumps, mud pumps, and other, similar plunger or piston pumps adapted to pump a fluid (e.g., including, but not limited to fluids, slurries, and other fluid media). The high performance sealing assembly further will be configured to provide greater protection against degradation of the seal between the piston and the pump housing due to exposure to high temperatures and/or friction during operation of the pump.

For example, during operation of a pump, a reciprocating motion between a plunger and a seal, such as, for example, a packing seal assembly, may result in development of heat, causing the temperature of the packing seal assembly to increase. In some instances, the increase in temperature may lead to degradation of the packing assembly seal. Accordingly, a high performance sealing assembly are described herein, which, in embodiments, may comprise a packing seal assembly for a pump that is configured to facilitate the transfer heat (e.g., provide an increased and/or more rapid dissipation of heat) to surrounding components of the pump, thereby to reduce the temperature of the packing seal assembly, so as to reduce the rate of degradation of the packing seal assembly and thereby extend its useful service life. In embodiments, the high performance sealing assembly of the present disclosure may include one or more seal elements defining a seal body, which, in embodiments, may include a first or base component and a second component that may comprise one or more additive or second components integrated with the base component and which are adapted to increase the thermal conductivity of the packing seal assembly.

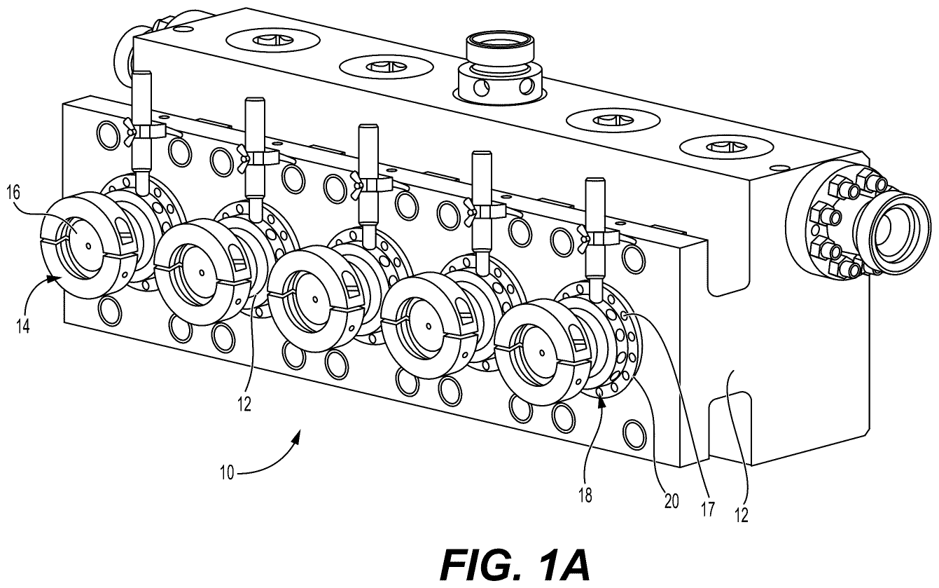

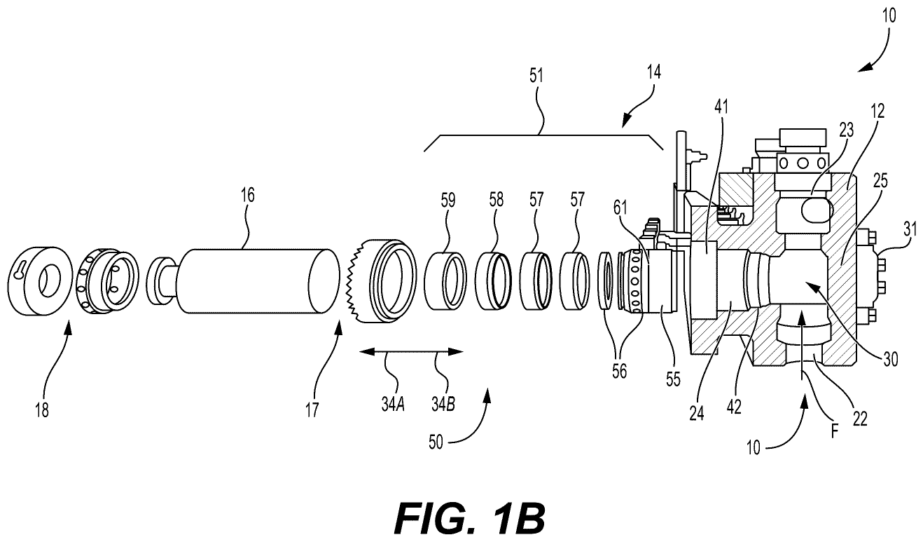

FIGS. 1A-1B illustrate an example embodiment of a fluid end 10 of a pump. In embodiments, the pump may comprise a hydraulic fracturing pump with one or more reciprocating plungers. As noted above, such a fluid end 10 may be utilized in various industrial applications, such as oil and gas applications, to deliver high-pressure fluids to piping components leading to wellbores. In addition, although embodiments of the pump 10 are described herein as being a “hydraulic fracturing pump” for pumping hydraulic fracturing fluid for the purpose of discussion, the pump 10 may be any other type of pump, such as, for example, any type of high-power pump, high-pressure pump, reciprocating pump, and/or high-flow rate pump suitable for pumping solids, semi-solids, slurries, liquids, fluids, or combinations thereof. In some embodiments, the pump 10 may be, for example, a hydraulic fracturing pump for pumping solids, semi-solids, slurries, liquids, fluids, or combinations thereof, such as hydraulic fracturing fluid.

In embodiments, the fluid end 10 may be coupled to a power end of the pump, which in turn may be connected to an engine, which provides motive power for driving reciprocation of one or more plungers. By way of example only, the engine may provide sufficient power to pump a fluid at volumes that may range from, for example, about 1,500 to about 4,000 gallons per minute, and at fluid pressure ranges from 5,000-25,000 pounds per square inch (psi). It should be noted that these fluid pumping volume and pressure ranges are provided by example and are not intended to limit the scope of the present disclosure, as, in embodiments, the fluid volumes may be below 1,500 gallons per minute or greater than 4,000 gallons per minute and the pressures ranges may be less than 5,000 psi or greater than 25,000 psi in various applications.

In addition, in embodiments, the power end assembly may include a housing with mechanical power transmission components, such as a crankshaft, bearings supporting the crankshaft in the housing, crossheads, reduction gears, and/or connecting rods and plungers connected to the connecting rods; and in some embodiments, may be configured to convert power into reciprocating motion. For example, the power end assembly may be configured to convert and transfer rotational power into the reciprocating motion of the plungers, or may be configured to convert electric or hydraulic power into a reciprocating motion of the plungers.

As generally illustrated in FIGS. 1A-1B, in embodiments, the fluid end 10 may include a manifold body or housing 12 that is illustrated in FIG. 1B as a single, unitary piece, but also may be formed of multiple sections. The housing 12 further generally will include an inlet 11 that is configured to receive a low pressure fluid, an internal chamber that receives a low pressure fluid, and an outlet at an opposite end of the chamber configured to discharge a high pressure fluid.

In the illustrated embodiment, the fluid end 10 includes multiple (e.g., five) different plunger assemblies 14, each including a plunger 16, a retainer 17 and a packing nut 18, and a flange 20. The plungers 16 of the plunger assemblies 14 also may be coupled to the power end assembly of the pump, which may be connected to one or more motors or engines for driving operation of the plungers. Examples of power end assemblies and fluid ends in which the high performance sealing assembly may be utilized may be found in U.S. Pat. Nos. 11,421,680, 12,049,889, and 12,055,221, the disclosures of which are incorporated by reference as if set forth fully herein.

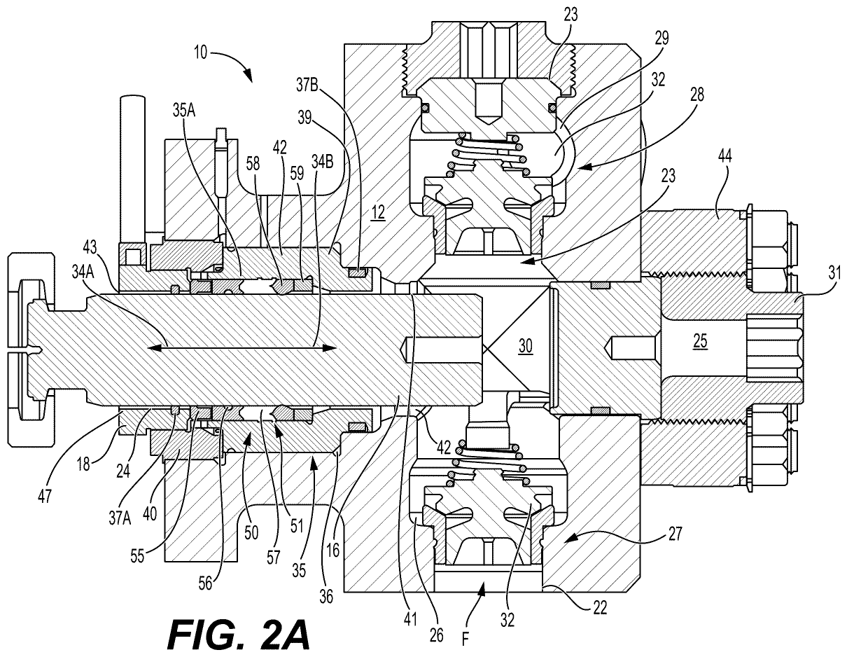

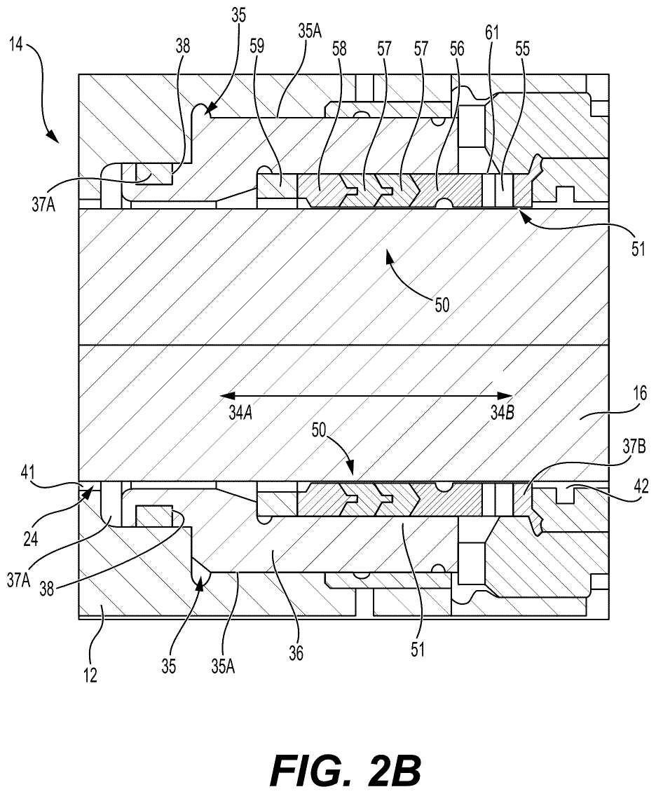

FIGS. 2A and 2B illustrate a cross-sectional side view of an example embodiment of a plunger assembly 14 of a fluid end 10 and a packing recess 19 thereof. As indicated in FIG. 2A, the plunger assembly 14 will be spaced along the housing 12 of the fluid end 10, and each generally may include series of intersecting fluid bores 15. For example, in embodiments, each plunger assembly 14 may include a fluid bore 15 including a suction or intake bore 22, a discharge or outlet bore 23, a plunger bore 24, and an access bore 25. In embodiments, the suction bore 22 and the discharge bore 23 may be aligned such that they share a common central longitudinal axis. In addition, in embodiments, the plunger bore 24 and the access bore 25 also may be aligned along a common central longitudinal axis.

In embodiments, a chamber 30 may be positioned at the intersection of the bores 22, 23, 24, and 25, and may include a volume or space where the plunger bores overlap. As the plunger 16 is moved via operation of, for example, a crankshaft and a respective connecting rod of the power end assembly 16, it at least partially retracts in a direction 34A along its plunger bore 24, causing a fluid F to be drawn into the chamber 30 of the fluid end 10 via a suction port 26 of the section bore 22 while an intake valve 27 is open and a discharge valve 28 is closed. As each plunger 22 extends back toward the chamber 24 in direction 34B, pressurized fluid F is discharged from the fluid end 10 via the discharge bore 23 and a discharge port 29 while the discharge valve 28 is open and the intake valve 27 is closed.

In embodiments, the intake valve 27 and discharge valve 28 may be one-way valves or check valves may be positioned along each of the suction and discharge bores 22 and 23 and configured to allow fluid to flow therethrough in one direction but prevent the fluid from flowing therethrough in the opposing direction. For example, during operation of the pump, a low pressure fluid F may flow upward through the intake valve (e.g., a first check valve positioned adjacent an intake opening of the suction bore 22 and into the chamber 30) when a pressure differential across this check valve exceeds a predetermined amount. Thereafter, a higher pressure fluid F may be directed to flow upward through the discharge valve 28 (e.g., a second check valve positioned adjacent an outlet of the discharge bore to exit the chamber 30 when a pressure differential across this check valve exceeds a predetermined amount. In this example manner, the fluid end draws the fluid in at a first pressure and discharges the fluid F at a second, higher pressure. In some pump embodiments, the fluid end may include multiple (e.g., two, three, four, or five) sets of intake passages, cylinders, plungers, and discharge passages to pump fluid at high pressures and/or high flow rates. Other types of pumps, fluid end assemblies, and/or power end assemblies are contemplated.

In addition, in embodiments, an access cover 31 may be positioned at last partially within or over an access port 31 for the access bore 25, and may be secured with a threaded fastener such as a nut, which may be selectively removed to enable access into the chamber of the plunger assembly 14 via the access bore 25.

In some embodiments, a retainer assembly also may be used to secure the access cover 31 within the access port 31, and, in some embodiments, may include an outer housing configured to be secured to an exterior surface of the fluid end housing adjacent the access port; for example, engaging a receiver aperture provided with corresponding interior retainer threads. The retainer assembly further may include a retainer body having exterior retainer threads configured to threadedly engage the interior retainer threads. In some embodiments, the access cover 31 also may include a shoulder and a flange having an exterior end opposite an interior end facing the access bore configured to abut the exterior surface of the fluid end housing adjacent the access port. The retainer body may be threaded into the housing and abut the exterior end of the cover, thereby to secure the cover assembly in the access port. In embodiments, an annular seal also may be provided between an interior surface of the access port and an exterior surface of the cover, thereby to provide a fluid seal between the access port the cover when the cover is received in the access port. For example, the cover may include on the outer cylindrical surface thereof an annular groove, and a gasket or ring seal may be at least partially received in the annular groove.

As shown in FIGS. 2A-2B, in some embodiments, the plunger assembly 14 may include a packing recess 35 located along the plunger bore 16 and at least partially defining a packing recess bore 36. In some embodiments, a high performance sealing assembly 50 may be received in the packing recess bore 36 of the packing recess 35, operating to enhance a fluid seal between a surface 35 of the packing recess 36 and a surface 16 of the plunger 16 reciprocating along the plunger bore 24. The packing recess bore of the packing recess may be substantially cylindrical, having a substantially circular cross-section, with an outer surface of the high performance sealing assembly contacting the surface 35 of the packing recess 16. The packing assembly 35 may be configured to at least partially receive therein the plunger 16 as the plunger 16 reciprocates, thereby to draw fluid F into the chamber 30 at a first pressure via the intake or suction port 26 during movement of the plunger 16 in the first direction 34A and discharge fluid F from the chamber 30 at a second pressure greater than the first pressure via the discharge port 29 during movement of the plunger 16 in the second direction 34B, for example, as shown in FIG. 2A.

As shown in FIG. 1, first and second annular seals 37A/37B may be provided between the interior surface 35A of the packing recess 35 and an exterior surface of the high performance sealing assembly 50, thereby to provide a fluid seal between the first and second components of the pump, for example, between the packing recess 35 and the packing sleeve 39, e.g. adjacent of an end of the packing sleeve is placed in the packing recess. For example, as shown, the packing sleeve 36 may include, on the outer cylindrical surface an annular groove 38 at one or both ends, in which the first and second annular seals may be received.

As further illustrated in FIG. 2A, in embodiments, the high performance sealing assembly 50 may be positioned along each plunger bore between each plunger and the housing. In some embodiments, such as shown in FIGS. 2A and 2B, the first annular seal 37A further may be provided between the bousing 12 and the plunger bore 24, and may be positioned along the plunger bore 24 or the retainer sleeve 35 adjacent a downstream end 41 of the plunger bore; with the second annular seal 37B may be positioned adjacent an upstream end 42 of the plunger bore 24. In embodiments, the second annular seal 37B may be engaged between to the housing 12 and packing nut 18, which may be threadably coupled to the housing as shown in FIG. 2B. As the packing nut is tightened against the housing, the high performance sealing assembly may be compressed between the annular seals and the housing adjacent the ends of the packing recess as needed to form a substantially tight seal between the plunger and the housing.

As shown in FIGS. 2-4, in an embodiment, the high performance sealing assembly 50 may comprise a sealing assembly such as a packing seal assembly 51 positioned along each plunger bore 24 between the plunger 16 and a side wall of the plunger bore defined through the housing 12, and having a passage of bore defined therein and through which the plunger is reciprocated. The high performance sealing assembly 50 further may include a plurality of seal elements 52 defining an annular seal body 53, including, for example, a lantern ring 55 that may be positioned at the upstream end and may be engaged by the packing nut or adjacent annular ring, an adapter ring 56 behind the lantern ring, one or more pressure rings 57 stacked behind the adapter ring, and a header ring 58, a scraper ring, or various combinations thereof, on the opposite side of the pressure rings.

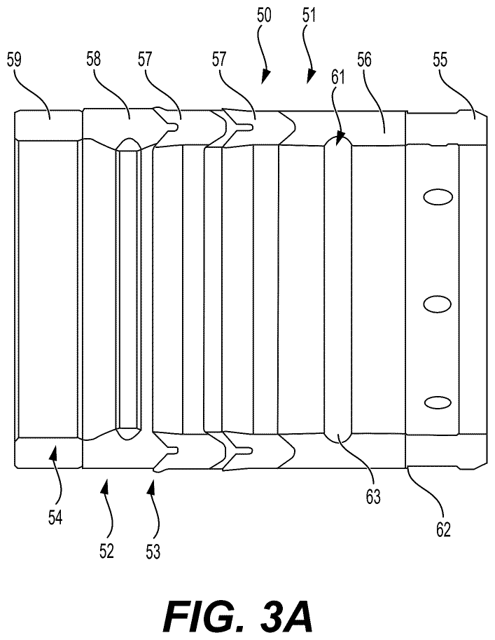

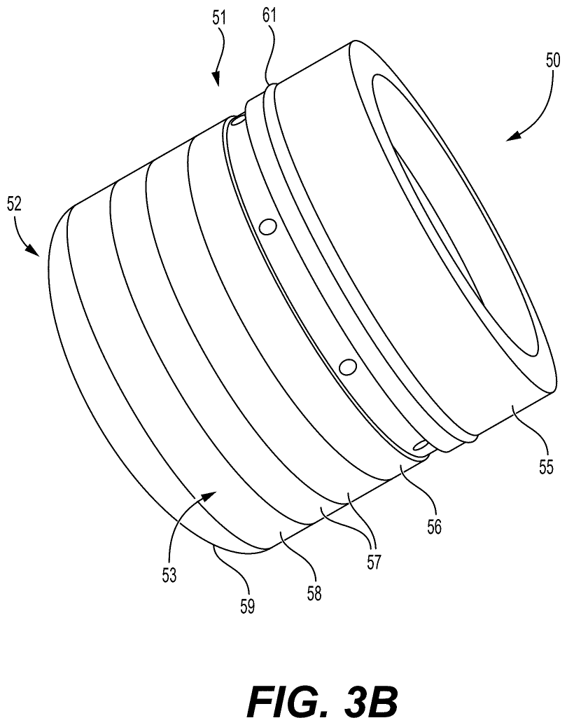

In some embodiments, the high performance sealing assembly also may include a junk ring 59 adjacent the header ring 58 and/or a scraper ring, such as shown in FIG. 3. Still further, in embodiments, seals or gaskets, such as a lube seal 61, may be positioned between one or more of the seal elements, e.g., between the lantern ring 55 and the adapter ring 56. In addition, in embodiments, such seals 61 could be received within a groove or recess 62 (FIG. 4) of the lantern ring 55 and/or a recess 63 of the adapter ring. It will additionally be understood that the seal elements could include additional or fewer components.

The seal elements further may comprise different materials. For example, in embodiments, the lantern ring 55 may be formed from an aluminum or aluminum alloy, such as a bronze alloy, or similar material having sufficient strength to engage with the adjacent ring or packing nut 18 during compression of the high performance sealing assembly. In embodiments, the adapter ring 56 similarly could be formed from an aluminum bronze material, or, in some embodiments, also could be formed from a composite or polymer material.

In embodiments, the one or more pressure rings 57 and/or header ring 58 may comprise a first or base component that may include a first or base material such as a polymer, and may have an additive component combined therewith (e.g., as a mixture or as an outer sleeve or covering) and which is selected to increase the thermal conductivity of the pressure rings and header for increased dissipation of heat. For example, the base component of the one or more pressure rings may include one or more of fabric, composite, nitrile rubber (HNBR), polytetrafluoroethylene (PTFE), thermoplastic polyurethane (TPU), or RESILON. In some embodiments, the junk ring 94 may include one or more of composite, steel, brass, bronze, aluminum, or polyether ether ketone (PEEK). Other materials for one or more of the rings are contemplated.

Additionally, the junk ring 59 typically will be formed from a metal such as steel or other high strength material. For example, in some embodiments, the junk ring 94 may include one or more of composite, steel, brass, bronze, aluminum, or polyether ether ketone (PEEK). Other materials for one or more of the rings are contemplated.

As further illustrated in FIGS. 2B-4, in embodiments, the seal elements may be provided with a geometry configured to enable one or more of the seal elements to engage and nest within an adjacent packing seal element to strengthen the engagement and seal therebetween and reduce seal wear. For example, the header ring 58 and one or more of the pressure rings 57 may be configured with an angled outer diameter surface and/or a projecting tongue 64 at the upstream side thereof, and a complimentary recess or groove 66 along the downstream side, e.g., defining a chevron or V-shaped profile. The header and pressure rings also may include one or more flared sealing projections 67 configured to overlap an adjacent packing seal element to further enhance the seal created between the plunger and the plunger bore of the fluid end. As further shown in FIG. 2, the seal elements may fit together in a nested sealing arrangement forming a packing stack defining an annular seal body 70 that surrounds the plunger 16.

In an example embodiment, during operation of the pump, the plunger 16 of each plunger assembly 14 will be at least partially received within its corresponding plunger bore 24, and will be moveable therealong in a reciprocating motion indicated at arrows 34A/34B. As described above, an end of each plunger may be coupled to the power end of the pump, so as to cause the plunger to move axially back and forth (i.e., reciprocate) within its plunger bore. When the plunger 14 moves in a first direction 34A away from the chamber 30 (e.g., to the left in FIG. 2), a pressure differential is created across the intake valve of the intake or suction bore 22 so as to cause fluid to be drawn into though the inlet port 26 and the suction bore, and into the chamber 30. Thereafter, when the plunger 16 is reciprocated back toward the chamber in the direction of arrow 34B (e.g., to the right in FIG. 2), a pressure differential will be created across the discharge valve of the discharge or outlet bore 23 so as to cause the fluid to flow from the chamber 30 through the check valve and the discharge bore 23, and out the discharge opening or port 29. The pressurized fluid may then be supplied for a desired application, such as, for example, being introduced into a wellbore after it exits the fluid end.

As the plungers 16 slide along their plunger bores 24, the outer side surface of each plunger generally will be in tight sealing engagement, and thus in direct, frictional contact with the seal elements of the high performance sealing assembly 50 to seal the space between the side wall of the plunger bore 24 and the outer side surface of the plunger against leakage of fluid through the plunger bore, as shown in FIG. 2. As the plungers are reciprocated along their plunger bores, the frictional sliding contact between the seal elements and the outer side surface of the plungers generates a substantial amount of heat that is applied to the seal elements. Typical materials used for seal elements generally have included elastomers, thermoplastics, and polyamides. In addition, such materials have been reinforced with various materials including aramid or para-aramid fibers that may be applied as a wrap or added to the base material to increase the hardness of the seal elements. However, materials such as rubber and polyurethanes, as well as reinforcing fiber materials such as aramids and polyamides (e.g., nylon), generally have lower thermal conductivities. For example, rubber and polyurethane materials may have thermal conductivities in a range of 0.1 Watts per meter Kelvin (W/mK) to 0.5 W/mK, while materials such as nylon (polyamide) may have a thermal conductivity of 0.2 W/mK, and aramids may have a thermal conductivity of 0.04 W/mK. Combining materials such as rubber with materials such as aramids and polyamides further may result in a reduced overall thermal conductivity of the seal elements.

To address the effects of heat generated by the reciprocating movement of the plungers along their plunger bores, in embodiments, the high performance sealing assembly 50 of the present disclosure is configured to provide enhanced thermal conductivity of the overall seal between the high performance sealing assembly 50 and the plunger 16 and enable improved dissipation of heat generated by the reciprocation of the plungers through the seal and to surrounding components (e.g., the housing 12 of the fluid end 10, to the first and second sealing rings positioned along the plunger bore 24, to a packing sleeve, or other component of the pump housing, or combinations thereof). In addition, in some embodiments, to a lower temperature fluid being pumped through the fluid 10 end and circulated around the downstream end 41 of the plunger bore and the seal body 53 or packing stack of the high performance sealing assembly 50.

In embodiments, at least some of the seal elements may comprise a first or base component that may comprise a base material having a selected wear resistance and chemical resistance to debris and contaminants within the fluid flowing through the fluid end, or other wear resistant materials, and a second component that, in embodiments, may comprise an additive component. In embodiments, the additive component may comprise a thermally conductive material having a selected thermal conductivity that is greater than a thermal conductivity of the base material. The thermally conductive material may be combined or integrated with the base material, such as by mixing such materials in the form of powders, fibers, as a slurry, or otherwise, with the base material to form a composite seal material from which various ones of the seal elements such as the pressure and header rings (and other seal elements) may be formed.

In other embodiments, a combination of reduced coefficient of friction materials and materials having a selected thermal conductivity greater than the thermal conductivity of the base material may be combined with the base material, individually or together, to provide the resultant composite seal material with both an increased thermal conductivity to facilitate dissipation of heat from the seal elements by heat transfer to the housing or other parts thereof that are in contact with the seal elements, and/or to a lower temperature fluid being pumped through the fluid end and circulated around the downstream end of the plunger bore and the packing stack of the high performance sealing assembly.

In embodiments, various ones of the seal elements, including, but not limited to pressure rings 57, header ring 58, one or more sealing rings or gaskets between elements, and adapter ring 56 may include a base material that may comprise a polymeric material such as an elastomer, thermoplastic, and/or polyurethane material, or combinations thereof, mixed, blended, wrapped, impregnated, embedded or otherwise integrated with an additive component configured to increase dissipation of heat due to movement along the plunger bore in contact with the sealing assembly.

In some example embodiments, the first or base component may comprise various polymeric materials, which may include, but are not limited to, an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof.

In embodiments, the additive component may include a thermally conductive material having a thermal conductivity greater than the thermal conductivity of the first or base material(s) of the first or base component, and which will be blended with, mixed with, embedded into, wrapped about, or otherwise integrated with the base component so as to provide the seal elements with a total thermal conductivity that is greater than the thermal conductivity of the base component alone. By way of example only, in various embodiments, the thermally conductive material may include one or more of the following materials that may be added to the base materials to form a composite seal material having an increased thermal conductivity and wear resistance:
1) Boron Nitride
2) Graphene
3) Silicon Carbide
4) Carbon nanotubes
5) Aluminum or Al-containing compounds (e.g., Alumina ceramic materials)
6) Copper or Cu-containing compounds and/or Copper alloys (e.g., brass; bronze
7) Zinc or Zn-containing compounds
8) Silicon or SI-containing compounds (e.g., silica and silicates such as glass, thermally conductive silicone or other thermal grease materials, silica aerogels)
9) Silver and/or Silver alloys
10)Steel and/or Steel alloys
11)Magnesium Oxides
   The foregoing list of materials having a higher thermal conductivity is not to be considered limiting and other thermally conductive materials also may be used.

In addition, in some embodiments, the additive component may include materials selected to provide the composite seal material with a reduced coefficient of friction integrated therewith. This may help reduce the need for or use of lubricating materials such as oils, grease, etc. that may potentially lead to degradation of one or more of the seal elements. For example, in embodiments, a thermal grease material, such as thermally conductive silicone, may be added to a base material of one or more of the seal elements, applied along an outer surface of one or more of the seal elements (e.g., along an outer surface of the body of the high performance sealing assembly), or combinations thereof.

In embodiments, the additive components may be added to the first or base material while the base material is in a substantially liquid or semi-liquid state. For example, depending on the base material used, the additive component material may be added as fibers, flakes, particles, or in an agglomerate form. In some embodiments, one or more additive components may be mixed with the base material to provide a substantially uniform distribution of the additive component material(s) throughout the base material, however, in other embodiments, the additive component material(s) may not be uniformly dispersed within the base material, for example, being concentrated along portions of the composite seal material such as adjacent a surface of the packing seal element formed from the composite seal material. The additive components further may be added to the base material during molding or extrusion of the seal elements.

In addition, in embodiments, the additive components may be combined with the base material(s) to a range of approximately 0.5% to approximately 20% by volume of the composite seal material. Greater or lesser amounts of such additive component materials also may be provided. Still further, various different materials may be combined and added to the base material to form the composite seal material. For example, in embodiments, one or more of the above listed materials could be combined, e.g., boron nitride could be combined with graphene, silicon carbide, carbon fibers or carbon nanotubes, various metals or metal containing compounds (e.g., Al, Cu, or Zn), or combinations thereof to form an additive component material having a selected weight percentages of such materials. Such a multiple material additive component may be combined with the base material in a range of, for example, approximately 0.5% to approximately 20%, though greater or lesser amounts also may be utilized.

In addition to mixing, embedding or otherwise generally integrating the thermally conductive material of the additive component with the base material of the seal elements, the additive component(s) further could be applied to the base component as a separate component of the packing seal element. For example, in embodiments, high conductivity metals or metal alloys (e.g., steel, Al, Cu, Zn, or combinations thereof) in the form of a metal and/or metal alloy mesh, metal and/or metal alloy fibers, including loose metalized fibers, metal and/or metal alloy sheet materials including metalized fabrics or ribbons, metal and/or metal alloy flakes, metal and/or metal alloy filaments, a woven metal and/or metal alloy mesh, metal and/or metal alloy chips, or combinations thereof.

In some embodiments, high conductivity metals and/or metal alloys may be mixed or blended with base component material(s) so as to be substantially integrated therewith. In other embodiments, high conductivity metals and/or metal alloys for the additional components may be applied about a base material geometry of one or more of the seal elements as a sleeve, covering or wrapping that may be molded with the base material, compressed into the base material, laminated to the base material, or otherwise integrated with the base material. In some embodiments, high conductivity metals and/or metal alloys may be applied as a sleeve, covering or wrapping in addition to or as an alternative to mixing, blending or otherwise combining such high conductivity metal or metal alloy materials with the base material.

The seal elements formed from the composite seal material will have an increased thermal conductivity of at least about 0.45 W/mK to 1.0 W/mK, or greater, without a reduction in the wear resistance of the seal elements. In some embodiments, the seal elements further may be provided with an increased wear resistance, and also may have an increased resistance to contaminants and corrosive materials, in addition to increased thermal conductivity. The increased thermal conductivity of the seal elements, and thus the packing seal stack as a whole, will enable heat generated by friction due to the plunger reciprocating along the plunger bore in sliding frictional contact with the high performance sealing assembly to be transferred through the seal elements to components of the housing of the fluid end, and/or to a lower temperature fluid being pumped through the fluid end and circulated around the downstream end to the plunger bore and the packing stack of the high performance sealing assembly.

Still further, in some embodiments, the additive component(s) may comprise a material having a low coefficient of friction. Such materials may include, without limitation, fluoropolymers such as PTFE or PTFE-containing compounds, graphene or graphene-containing compounds, lanolin, MoS₂ or MoS₂-containing compounds, and other, similar materials, and combinations thereof. Such low coefficient of friction materials may be combined with the base material such as by mixing such materials (e.g., as a powder, flakes, or other form) so as to substantially integrate the material with the base material, or by coating the base material geometry along at least one surface (e.g., a surface on contact with the plunger), or applying to the base material geometry in its entirety. The resultant reduction in friction of the seal elements will help reduce the heat generated by the reciprocation of the plunger along the plunger bore in contact with the packing seal stack.

In embodiments, a combination of material(s) having an increased thermal conductivity and material(s) having a lower coefficient of friction also may be used. For example, a material with an increased thermal conductivity may be integrated with the base material, and a material with a low coefficient of friction could be applied, such as by coating the base material geometry of a packing seal element formed thereby with such a material. In some embodiments, both a low coefficient of friction material and a material with a higher thermal conductivity could be integrated with the base material to form a composite seal material from which the seal elements may be formed. Still further, in other embodiments, a protective sleeve of a thermally conductive material (e.g., a metal or metal-containing material) may be applied to the base material geometry and then a low coefficient of friction material applied thereto.

In addition, in current packing seal constructions, seal elements 52 such as pressure rings 57, and/or header rings 58, may be formed from a fabric reinforced elastomer. Such reinforcing fabrics often include fabric materials selected for characteristics such as high wear resistance. However, such reinforcing fabric materials typically have low thermal conductivities such that the fabric reinforcement materials may act as an insulator that traps heat generated by the reciprocation of the plunger along the plunger bore.

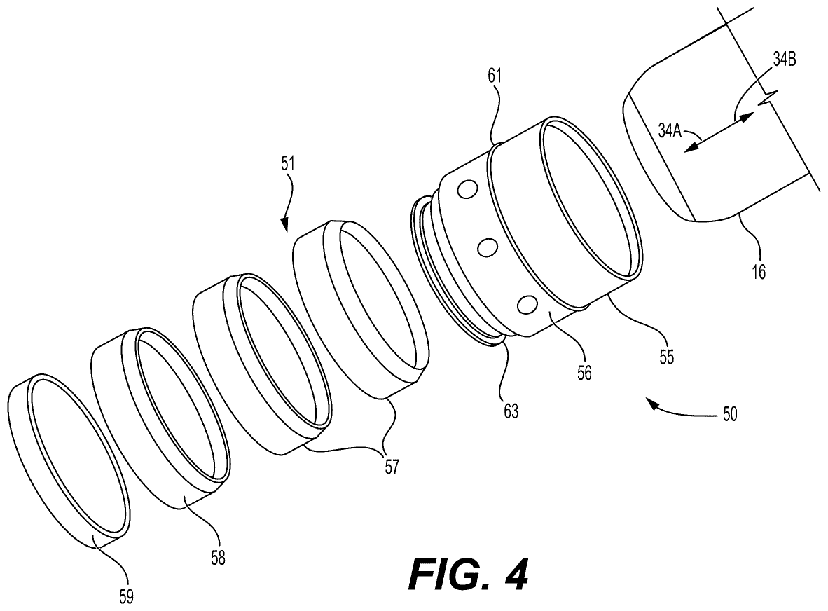

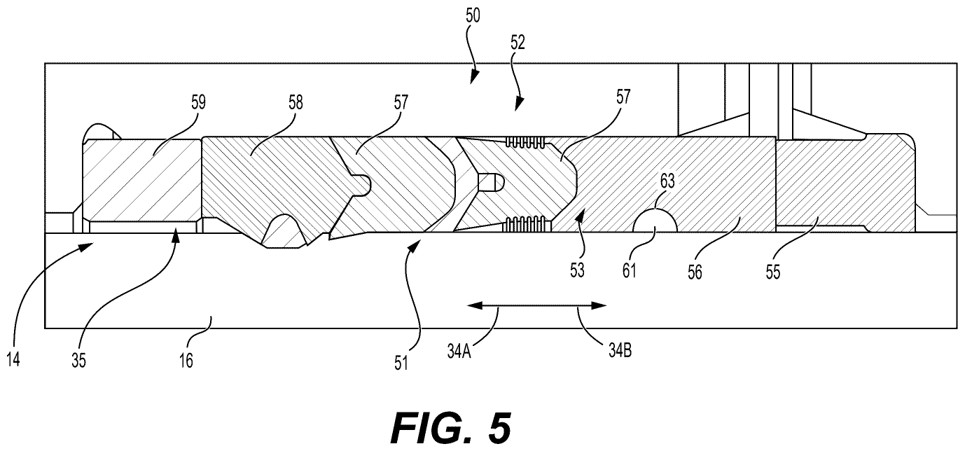

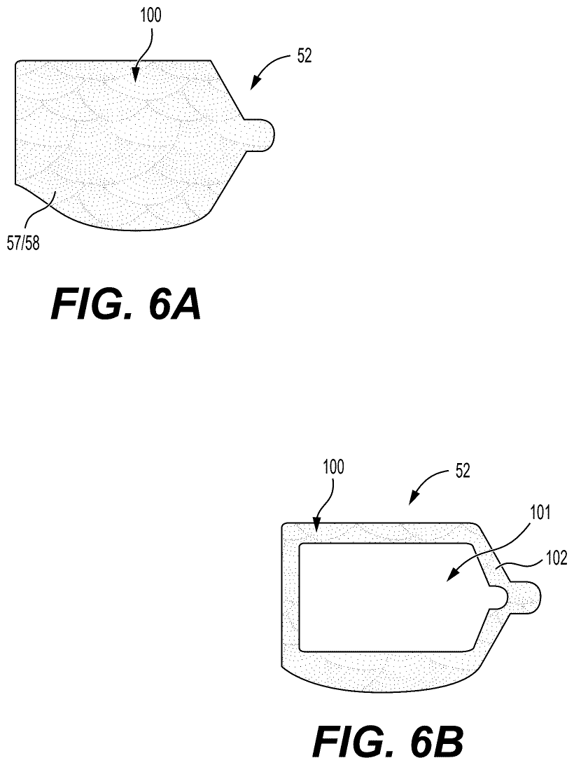

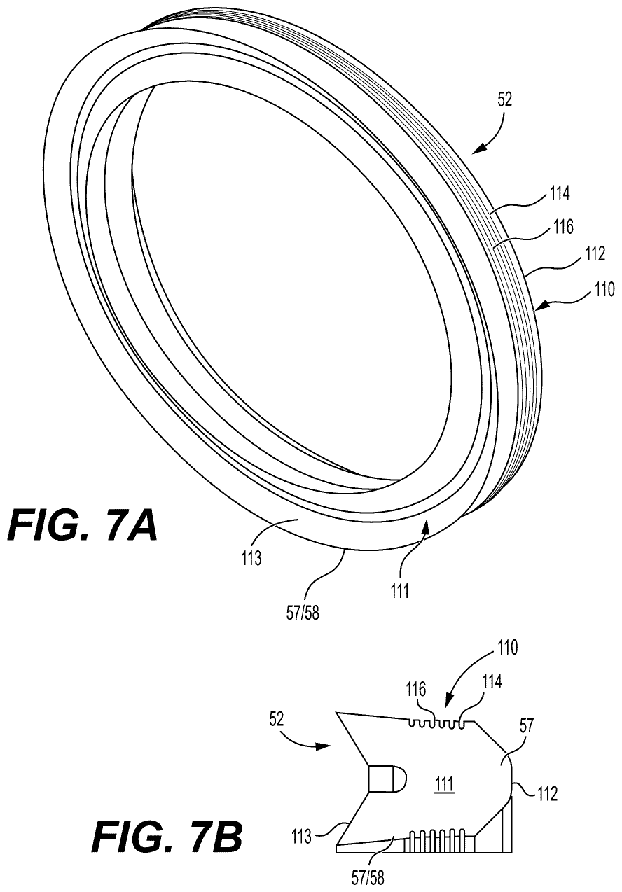

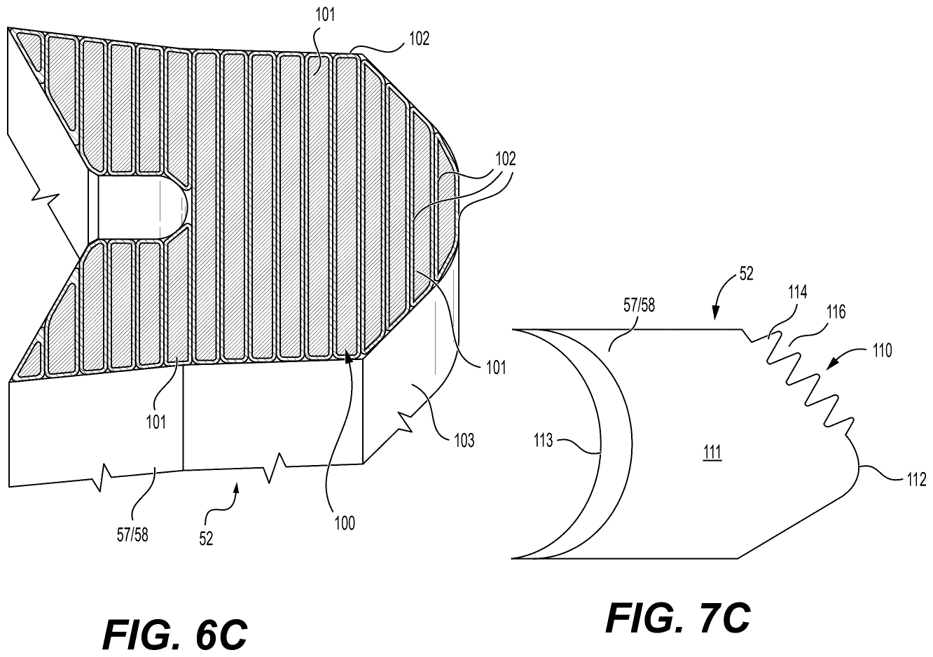

In some embodiments, the seal elements 52 (FIG. 5) may be molded or otherwise formed from a thermally conductive reinforcing fabric having a higher thermal conductivity, which, in embodiments, may include a carbon fiber reinforced fabric material or wrapping. For example, in embodiments, such as shown in FIGS. 5-6B, one or more of the seal elements 52 of the high performance sealing assembly 50, such as pressure rings 57 and/or header rings 58 may be formed from a fabric reinforced material that may include a thermally conductive reinforcing fabric material 100 which, in embodiments, may incorporate carbon fibers in selected amounts or concentrations. In embodiments, such a carbon fiber-based thermally conductive reinforcing fabric material may be designed to exhibit substantially increased thermal conductivity.

For example, in embodiments, the carbon fiber-based thermally conductive reinforcing fabric materials 100 may exhibit thermal conductivities in a range of upwards of 10-200 W/mK, so as to provide a substantial increase in the thermal conductivity of the seal elements to facilitate the dissipation of heat generated during reciprocation of the plunger along the plunger bore in sliding contact with the seal elements of the packing seal assembly 51, such as by enhancing and facilitating transfer of heat through the packing seal assembly from a first component of the pump (e.g., the plunger), to a second component of the pump, to a fluid passing through the pump, or a combination thereof, to reduce a temperature of the packing seal assembly without unduly increasing in the rate of wearing of the seal elements. As a result, the operating life of the packing seal assembly may be substantially extended.

In embodiments, the thermally conductive reinforcing fabric material 100 may include a first component comprising binder material component including a selected binder material, and a second component, comprising a fiber material component including a selected amount or fiber content of carbon fibers. By way of example, in some embodiments, the thermally conductive reinforcing fabric material may comprise up to about 100% carbon fibers that will be mixed or otherwise combined with the binder material to form a thermally conductive reinforcing fabric reinforced material from which the seal elements may be formed. In some further embodiments, the carbon fibers also may be combined with additional fabric material fibers, which may be selected to provide further enhanced properties or characteristics, such as wear resistance, reduced friction, enhanced sealing, etc.

For example, in embodiments, the thermally conductive reinforcing fabric may comprise the binder material and a plurality of fibers including between about 5% to about 100% by fiber content weight of carbon fiber. In some embodiments, the plurality of fibers further may one or more secondary fibers/fabric materials, for example, in embodiments, including between about 0% to about 95% of secondary fibers mixed with the carbon fibers and the binder material. Such secondary fibers/fabric materials may include materials such as aramid based fabrics, natural fibers/fabrics such as cotton, polymers such as PET, and other fibers. In embodiments, the binder materials may include urethanes, elastomers, rubber materials, thermoplastics (e.g., Butyl rubbers, Acrylonitrile Butadiene Rubber (NBR), Hydrogenated Nitrile Butadiene Rubber (HNBR), fluoropolymer elastomers such as Vitron™, silicones, tetrafluoroethylene-propylene (TFE/P) copolymer such as AFLAS®, Ultra High Molecular Weight Polyethylene (UHMW), etc.).

In some embodiments, where, for example, the seal elements comprise a pressure ring or a header ring, the carbon fibers or carbon fiber and secondary fiber mix may be combined with the binder material formed as a woven fabric, non-woven fabric, knit, or short fiber fabric. Other fabric constructions also may be provided.

In embodiments, such as shown in FIGS. 5-6A, the highly thermally conductive reinforcing fabric material 100 may be formed into a substantially homogeneous mixture and subjected to one or more of heat and compression such as by placing the mixture in a mold configured for forming a selected seal element configurations and molded or otherwise formed into the seal element 52 (e.g., a pressure ring, header ring or other seal element). As further illustrated in FIGS. 5 and 6A, in embodiments, the binder and fabric mixture of the thermally conductive reinforcing fabric material 100 may be formed as a sheet material that may be arranged in layers or pieces that may be arranged in various configurations, for example, in an overlapping configuration as indicated in FIGS. 5-6A, and subjected to one or more of heat and compression to form the seal element.

In other embodiments, the thermally conductive reinforcing fabric material 100 may be formed as a reinforcing fabric that then may be applied about a core 101 or a base material. For example, as illustrated in FIG. 6B, the thermally conductive reinforcing fabric material may be wrapped or applied as a covering about an outer surface or diameter of an elastomer core 101 such that, in embodiments, the core 101 may be substantially encapsulated by and thus substantially integrated with the thermally conductive reinforcing fabric material to form the seal element. In some embodiments, the core 101 material wrapped with the thermally conductive reinforcing fabric material 100 may be molded, such as by being placed into a mold and subjected to heat and/or compression to form the seal element. In other embodiments, the core may be formed with a selected seal element configuration and wrapped with the thermally conductive reinforcing fabric material, and then subjected to heat to seal the core within the thermally conductive reinforcing fabric material wrapping.

In still other embodiments, such as shown in FIG. 6C, the thermally conductive reinforcing fabric 100 may be formed as a reinforcing sleeve within which a core of a sealing material, or other material may be received. For example, rather than being formed as a sheet, in some embodiments, the thermally conductive reinforcing fabric may be formed as a tubular or cylindrical sleeve 102, with or without one or more closed ends or section; and in some embodiments may be selectively sized to form a seal element of a selected thickness and/or diameter.

In embodiments, the sealing material (e.g., a core or base component 101), may be received within the thermally conductive reinforcing fabric sleeve 102 so as to be substantially encapsulated therein, for example, such as generally illustrated in FIGS. 6B and 6C. In embodiments, the sealing material may include one or more of polymer, thermoplastic polymer, thermosetting polymer, elastomeric polymer, elastomer, thermoplastic, thermosetting plastic, natural rubber, synthetic rubber, nitrile, butadiene rubber, polyether ether ketone (PEEK), fabric-reinforced rubber, aramid-reinforced rubber, fiber-reinforced rubber, fluorocarbon resin, thermoplastic polyurethane (TPU), thermoplastic copolyester (COPE), ethylene propylene diene monomer (EPDM), highly saturated nitrile rubber (HNBR), thermoplastic polyurethane (TPU), or polyurethane, as well as one or more other materials having similar material and/or performance characteristics. In addition, in some embodiments, one or more friction reducing agents also may be added to and dispersed within the thermally conductive reinforcing fabric sleeve (and, in some embodiments, could also be combined with the material of the sealing material core 101) to reduce friction at a seal interface between the packing seal assembly and a machine component (e.g., a plunger), so as to reduce heat generation and extend a service life thereof. For example, and without limitation, friction reducing agents such as one or more of polytetrafluoroethylene (PTFE), virgin PTFE, glass-filled PTFE, graphite-filled PTFE, bronze-filled PTFE, or moly disulfide-filled PTFE, as well as one or more other materials having similar material and/or performance characteristics, may be dispersed throughout the thermally conductive reinforced fabric.

In embodiments, the sealing material core and thermally conductive reinforcing fabric sleeve may be twisted or wound, or otherwise formed in a seal element preform having a substantially helical, coiled or looped configuration. The preform may them be placed into a mold configured to form a seal element of a selected configuration, and may be subjected to one or more of heat and compression to form a molded seal element 52. The application of heat and/or compression during formation of the seal element generally may cause the sealing material of the core (e.g., the urethane, thermoplastic, elastomer, or other materials) with the carbon fiber-based thermally conductive reinforcing fabric. After application of heat and/or compression, the resultant seal element 52 may have a body 103 with a series of sections or layers 104 arranged in a wound, coiled or stacked layer configuration, such as indicated in FIG. 6C.

It will be understood by those skilled in the art that while a series of generally parallel layers 104, each including a portion of the core 101 encapsulated within the thermally conductive reinforcing fabric sleeve 102 is shown in FIG. 6C, in various other embodiments, the seal element 52 formed from such a preform may have various other configurations and/or arrangements of layers or sections. In addition, by substantially integrating the sealing material of the core with the thermally conductive reinforcing fabric, the fabric fibers may be sealed with the core. Further, in some embodiments, additional covering materials may be applied or incorporated into the seal element, for example, to provide the seal element with a substantially smooth outer surface. Such a construction of a seal element may help protect the fibers of the thermally conductive reinforcing fabric sleeve 102, for example, from exposure and direct contact with the plunger until an amount of the sealing material forming the one or more edges of the packing seal assembly/seal element is worn away by reciprocation of the plunger along the packing seal body to an extent sufficient to expose such fibers. In some embodiments, this may reduce the rate of degradation of the packing seal assembly, thereby extending its service life.

In some embodiments, the use of such carbon fiber-based thermally conductive reinforcing fabric materials 100 further may be used in conjunction with the use of the higher thermally conductive additive materials and/or lower or reduced friction additives, such as the use of PTFE, boron nitride, lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof, including the higher thermal conductivity materials as discussed above. For example, in embodiments, higher thermal conductivity additives and, in addition to or as an alternative to the addition of such higher thermal conductivity additives, friction modifier additives may be added to the thermally conductive reinforcing fabric material, such as by introducing or incorporating such higher thermal conductivity additives and/or friction modifier additives into the binder material prior to or during the mixing of the binder material component with the fiber material component.

In still other embodiments, such as illustrated in FIGS. 5 and 7A-7C, one or more of the seal elements 52 may be configured with a heat sink design (indicated at 110 in FIGS. 7A-7C). for example, the seal elements may comprise pressure rings 57 and/or header rings 58 each having a body 111 including a first end 112 and a second end 113. The body may be formed from various materials, including various elastomeric, polymeric and other reinforced materials including thermally conductive additives, friction modifier additives, and/or a wrapping or covering including a thermally conductive reinforcing fabric material, which, in embodiments, may include carbon fibers.

As generally illustrated in FIGS. 7B-7C, the heat sink 110 may be formed/defined along the body 111 of the seal element. For example, in some embodiments, the heat sink may be formed along an intermediate section of the body such as shown in FIGS. 5 and 7B, while in other embodiments, the heat sink may be formed along a surface of the outer side wall of the body adjacent the first end thereof, such as indicated in FIG. 7C. In addition, the heat sink 110 may include a series of fins 114 separated by recesses 116. The number of fins and the configurations thereof may be selected to facilitate the dissipation of heat, and thus help enhance the transfer of heat from the first component of the pump (e.g., a plunger) to a second component of the pump (e.g., a portion of the pump housing or side wall of the plunger bore, packing recess, etc.), to a fluid passing through the pump, or a combination thereof, to reduce a temperature of the packing seal assembly without unduly increasing in the rate of wearing of the seal elements.

In still other embodiments, to further help reduce and/or facilitate and enhance the transfer of heat generated by the reciprocation of the plunger along its plunger bore during operation of the pump through the packing seal, away from the plunger and to a second component of the pump (e.g., a portion of the pump housing or side wall of the plunger bore, packing recess, etc.), to a fluid passing through the pump, or a combination thereof, a coating further may be applied to the plunger. For example, in some embodiments, the plunger may be provided with a coating such as PTFE to which a thermal conductivity additive, such as boron nitride graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof, may be added. Friction modifier additives also may be added for reducing the friction between the surfaces of the plunger and the packing seal assembly and the plunger bore to help reduce heat generated by friction.

Still further, in other embodiments, the packing seal assembly may include a variety of configurations and arrangements of seal elements. For example, as indicated in FIG. 5, multiple pressure rings may be provided, with one or more of the pressure rings having a different configuration and/or being formed from different materials configured to facilitate increased transfer and dissipation of heat. This could include, in embodiments, providing one or more pressure rings and/or one or more header rings formed from highly thermally conductive reinforcing fabric materials, including carbon fiber-based thermally conductive reinforcing fabric materials, in addition to or as a further alternative to the integration/application of high thermal conductivity additives to the materials for forming the seal elements, such as discussed with respect to the above embodiments. Additionally, is some embodiments, the seal elements may be formed with a reduced diameter or profile (e.g., shortening the space or distance between the plunger and the pump housing) to facilitate transfer of heat between the plunger and the pump housing or other component; or may otherwise be configured to facilitate dissipation of heat through the packing seal assembly.

According to other aspects and embodiments of the present disclosure, methods for forming a high performance sealing assembly, such as a packing seal assembly for sealing a plunger bore of a pump (e.g., a high pressure reciprocating hydraulic pump) and for enhancing a seal between a surface of a first component of a pump and a surface of a second component of the pump are provided.

In embodiments, such methods may include positioning the high performance sealing assembly between the surface of the first component and the surface of the second component, for example, along a plunger bore between a plunger and a portion of the housing of the pump. In various embodiments, the high performance sealing assembly may comprise a packing seal assembly comprising an annular seal body, which, in embodiments, may include a plurality of seal elements configured to provide a desired wear resistance and an increased thermal conductivity designed to facilitate heat transfer between the first and second components.

In embodiments, the seal elements may include a first or base component including a first component or a base material, which, in embodiments, may comprise a sealing material that may include a lower friction material; and one or more second components, which, in embodiments, may comprise additive components having high thermal conductivity. In embodiments, the high thermal conductive materials may be integrated with or applied about the base material (e.g., as a thermally conductive additive or enhancement), or as a thermally conductive reinforcing fabric wrapping or cover to increase a thermal conductivity one or more of the seal elements, and thus increase an overall thermal conductivity of the sealing assembly.

In some embodiments, the base component may comprise an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof. In addition, in various embodiments, thermally conductive materials such as boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof, may be added to the base material, with the resultant mixture being molded or otherwise formed into the seal element(s). In further embodiments, the thermally conductive materials may include carbon fiber-based thermally conductive reinforcing fabric materials wrapped about a sealing material core, or combined with the core material and molded or otherwise formed into the seal element(s).

In embodiments, the method may further include positioning the plurality of seal elements in a stacked arrangement to define the seal body of the packing seal assembly. The seal body may be positioned between a stationary component of the pump and one of (a) a reciprocating component of the pump or (b) a rotating component of the pump. For example, in embodiments, the packing seal assembly may be positioned extending along a portion of the plunger bore, such as being positioned within a packing recess.

The method further will include transferring heat (e.g., heat due to friction of the first component moving with respect to the second component during pumping of a fluid), via the enhanced thermally conductive seal elements, from the annular seal body to one or more of a first component of the pump (e.g., a plunger) or the seal body, to a second component of the pump (e.g., one or more of a packing sleeve, a fluid end block, a plunger, a portion of a housing, or combinations thereof), or, in some embodiments, to the fluid being pumped during operation of the pump, to reduce a temperature of the packing seal assembly and extend its service life.

This application claims benefit of U.S. Provisional Application No. 63/854,411, filed Jul. 30, 2025, titled “HIGH PERFORMANCE SEALING ASSEMBLY,” U.S. Provisional Application No. 63/774,172, filed Mar. 19, 2025, titled “HIGH PERFORMANCE SEALING ASSEMBLY,” and U.S. Provisional Application No. 63/694,645, filed Sep. 13, 2024, titled “HIGH PERFORMANCE SEALING ASSEMBLY,” the disclosures of which are incorporated herein by reference in their entirety.

The present disclosure has been described herein in terms of examples that illustrate principles and aspects of the present disclosure. The skilled artisan will understand, however, that a wide gamut of additions, deletions, alterations, and modifications, both subtle and gross, may be made to the presented examples without departing from the spirit and scope of the present disclosure. All such modifications which do not depart from the spirit of the disclosure are intended to be included within the scope of any of the aspects and/or claims provided by the present disclosure.

What is claimed is:

1. A high-pressure reciprocating pump comprising:
a housing;
at least one plunger assembly including a plunger received within a plunger bore extending through the housing and configured to move in a reciprocating motion along the plunger bore for pumping a fluid through a fluid chamber; and
a sealing assembly comprising a plurality of seal elements, at least one seal element of the plurality of seal elements including at least one component positioned to increase dissipation of heat due to movement along the plunger bore in contact with the sealing assembly, the at least one component comprising:
a first component including a first material having a thermal conductivity and a coefficient of friction, and
a second component including one or more of (a) a thermally conductive material having a thermal conductivity greater than the thermal conductivity of the first component or (b) a low coefficient of friction material having a coefficient of friction lower than the coefficient of friction of the first material.

2. The high-pressure reciprocating pump of claim 1, wherein the thermally conductive material comprises one or more of:
(a) boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, carbon fibers, or combinations thereof;
(b) a plurality of fibers, flakes, filaments, a mesh, sheet material, strips, ribbons, chips, or combinations thereof, of a metal and/or metal alloy integrated with one or more of the seal elements, applied about one or more of the seal elements, or combinations thereof; or
(c) one or more layers of a woven mesh, non-woven, a woven fabric, or non-woven fabric, or a combination thereof embedded within the first material, mixed or blended first material, attached to the first material, or combinations thereof.

3. The high-pressure reciprocating pump of claim 1, wherein the first component comprises a core, and the second component comprises a thermally conductive reinforcing fabric including a woven, non-woven, knit, short fiber, or combinations thereof.

4. The high-pressure reciprocating pump of claim 1, wherein the at least one component configured to increase dissipation of heat comprises one or more of:
(a) a thermally conductive reinforcing fabric, the thermally conductive reinforcing fabric comprising:
a plurality of thermally conductive fibers including about 5% to about 100% carbon fiber,
about 0% to about 95% of secondary fibers including aramid fibers, cotton fibers, PET fibers, or combinations thereof, and
a binder comprising urethane, elastomers, thermoplastics, rubbers, or combinations thereof; or
(b) a base material including a wear resistant material, a low coefficient of friction material, or a combination thereof, and an additive material having a thermal conductivity greater than a thermal conductivity of the base material, or a low coefficient of friction material having a coefficient of friction lower than a coefficient of friction of the base material, or a combination thereof.

5. The high-pressure reciprocating pump of claim 4, wherein the base material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof.

6. The high-pressure reciprocating pump of claim 1, wherein at least one of the seal elements includes a thermally conductive reinforcing fabric and further comprises at least one of a pressure ring and a header ring, the thermally conductive reinforcing fabric comprising one or more of:
(a) about 5% to about 100% carbon fiber;
(b) about 0% to about 95% of secondary fibers comprising aramid fibers, cotton fibers, PET fibers, or combinations thereof;
(c) about 0% to about 95% of a binder comprising: urethane, elastomers, thermoplastics, rubber, or combinations thereof; or
(d) carbon fiber and a binder, the binder comprising an elastomer, urethane, thermoplastic rubber, fiber reinforced rubber, PTFE, or combinations thereof.

7. The high-pressure reciprocating pump of claim 1, wherein one or more of:
(a) the at least one of the seal elements comprises a core wrapped with a thermally conductive reinforcing fabric;
(b) the plunger bore includes a packing recess defined therealong and a packing sleeve positioned along the packing recess between the sealing assembly and the housing; or
(c) the at least one plunger includes a coating, the coating comprising a thermally conductive material, a reduced friction material or a combination thereof.

8. The high-pressure reciprocating pump of claim 1, wherein one or more of:
(a) the high-pressure reciprocating pump further comprises a power end coupled to the housing and configured to transfer power for driving the reciprocating motion of the plunger along the plunger bore;
(b) the at least one seal element further comprises a heat sink defined along at least a portion thereof; or
(c) the at least one seal element comprises a pressure ring or a header ring.

9. The high-pressure reciprocating pump of claim 8, wherein:
the at least one seal element comprises a pressure ring or a header ring; and
the at least one component of the at least one seal element comprises a thermally conductive reinforcing fabric material including carbon fiber and a binder material.

10. The high-pressure reciprocating pump of claim 9, wherein one of:
the thermally conductive reinforcing fabric material is molded to form the at least one seal element; or
the fabric material is applied as a wrapping about a core.

11. The high-pressure reciprocating pump of claim 9, wherein the binder material further comprises a thermally conductive additive or a friction modifying additive, the thermally conductive additive or the friction modifying addition comprising PTFE, boron nitride, lanolin, magnesium containing compounds, graphene, Silicon or SI-containing compounds, carbon nanotubes, Aluminum or Al-containing compounds, Copper or Cu-containing compounds, Zinc or Zn-containing compounds, metal or metal alloys, or combinations thereof.

12. The high-pressure reciprocating pump of claim 1, wherein the plurality of seal elements comprises one or more of a lantern ring, a lube seal, an adaptor ring, a pressure ring, or a header ring.

13. A high-pressure reciprocating pump comprising:
a housing;
at least one plunger assembly including a plunger received within a plunger bore extending through the housing and configured to move in a reciprocating motion along the plunger bore; and
a sealing assembly including a plurality of seal elements positioned along the plunger bore between the plunger and the housing, at least one of the seal elements including:
a first material having a thermal conductivity and a coefficient of friction, and
a second material positioned to increase dissipation of heat due to movement along the plunger bore in contact with the sealing assembly, the second material including a thermally conductive material having one or more of (a) a thermal conductivity greater than the thermal conductivity of the first material or (b) a low coefficient of friction material having a coefficient of friction lower than the coefficient of friction of the first material.

14. The high-pressure reciprocating pump of claim 13, wherein the thermally conductive material comprises one of:
(a) a thermally conductive reinforcing fabric;
(b) a plurality of thermally conductive fibers including carbon fibers;
(c) boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof; or
(d) a plurality of fibers, flakes, filaments, a mesh, sheet material, strips, ribbons, chips, or combinations thereof, of a metal and/or metal alloy integrated with one or more of the seal elements, applied about one or more of the seal elements, or combinations thereof.

15. The high-pressure reciprocating pump of claim 14, wherein one of:
(a) the first material comprises a binder comprising an elastomer, urethane, thermoplastic rubber, fiber reinforced rubber, or combinations thereof substantially mixed with the carbon fibers; and wherein the at least one of the seal elements is molded from a mixture of the carbon fibers and the binder;
(b) the first material comprises a polymeric material, and the second material comprises boron nitride, graphene, Silicon or SI-containing compounds, carbon nanotubes, Aluminum or Al-containing compounds, Copper or Cu-containing compounds or copper alloys, Zinc or Zn-containing compounds, brass, bronze, silver, silver alloys, steel, steel alloys, magnesium containing compounds, or a combination thereof; or
(c) the first material comprises a low coefficient of friction material, and the second material comprises a material with a high thermal conductivity that is greater than a thermal conductivity of the first material; and wherein the second material is integrated with the first material so as to provide the at least one of the seal elements with a total thermal conductivity that is greater than the thermal conductivity of the first material.

16. The high-pressure reciprocating pump of claim 13, wherein the at least one of the seal elements comprises a core, and wherein first material comprises a binder and the second comprises a thermally conductive reinforcing fabric including a woven fabric, non-woven fabric, knit fabric, short fiber fabric, or combinations thereof, combined with the binder and wrapped about the core.

17. The high-pressure reciprocating pump of claim 13, wherein one of:
(a) the at least one seal element further comprises a heat sink defined along at least a portion thereof; or
(b) the at least one of the one or more seal elements comprises at least one lantern ring, at least one adaptor ring, at least one pressure ring, and at least one header ring, arranged in a stacked configuration defining a seal body; and
one or more of:
(1) at least one of the at least one pressure ring and the at least one header ring comprises a thermally conductive reinforcing fabric including carbon fiber and a binder; or
(2) the binder includes a thermally conductive additive, a friction modifying additive, or a combination thereof.

18. The high-pressure reciprocating pump of claim 13, wherein one or more of:
(a) the at least one of the seal elements includes at least one of at least one pressure ring and at least one header ring; and wherein the second material comprises a thermally conductive material configured to enhance thermal conductivity of the at least one pressure ring, the at least one header ring, or a combination thereof, so as to increase a transfer of heat generated by the reciprocating motion of the plunger along the plunger bore;
(b) the first material of the at least one of the seal elements comprises a wear resistant material, a low coefficient of friction material, or a combination thereof, and the second material comprises a thermally conductive reinforcing fabric having a thermal conductivity greater than a thermal conductivity of the first material and includes carbon fiber; or
(c) the first material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof.

19. The high-pressure reciprocating pump of claim 13, wherein the plunger includes a plunger coating to a surface of the plunger applied thereto, and wherein the plunger coating includes a filler material comprising a high thermal conductivity material, the high thermal conductivity material of the plunger coating comprising boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof.

20. The high-pressure reciprocating pump of claim 13, wherein one or more of:
(a) the at least one of the one or more seal elements comprises one or more of a pressure ring or a header ring, arranged in a stacked configuration;
(b) the one or more of the pressure ring or the header ring comprises a thermally conductive reinforcing fabric including carbon fiber and a binder;
(c) the binder includes one or more of a thermally conductive additive or a friction modifying additive; or
(d) the thermally conductive reinforcing fabric comprises one or more of aramid fibers, cotton fibers, or PET fibers.

21. A sealing assembly for a high-pressure reciprocating pump, the sealing assembly comprising:
a plurality of seal elements arranged in series to define an annular seal body having an outer surface, at least one seal element of the plurality of seal elements comprising:
(a) a first component including one or more of a wear resistant material or a low coefficient of friction material; and
(b) at least one additional component substantially integrated with the first component, the at least one additional component including one or more of (1) a thermally conductive material having a thermal conductivity greater than a thermal conductivity of the first component, or (2) a low coefficient of friction material having a coefficient of friction lower than a coefficient of friction of the first component, so as to facilitate increased transfer of heat from the sealing assembly to one or more of a first component or a second component of a pump.

22. The sealing assembly of claim 21, wherein one or more of:
(a) the first component of the at least one seal element comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof;
(b) the thermally conductive material comprises boron nitride, graphene, Silicon or SI-containing compounds, carbon nanotubes, Aluminum or Al-containing compounds, Copper or Cu-containing compounds, Zinc or Zn-containing compounds, brass, bronze, silver, silver alloys, steel, steel alloys, magnesium containing compounds, or a combination thereof; or
(c) the first component comprises a core, and the at least one additional component comprises thermally conductive reinforcing fabric applied about an outer surface of the core.

23. The sealing assembly of claim 21, wherein:
(a) the first component comprises a core, and the at least one additional component comprises thermally conductive reinforcing fabric applied about an outer surface of the core; and
(b) one or more of:
(1) the thermally conductive reinforcing fabric comprises a woven, non-woven, knit, short fiber, or combinations thereof; or
(2) the thermally conductive reinforcing fabric comprises:
a plurality of fibers including:
about 5% to about 100% of a primary fiber comprising carbon fiber; and
about 0% to about 95% of one or more secondary fibers; and
a binder, the binder comprising urethane, elastomers, thermoplastics, rubber, or combinations thereof.

24. The sealing assembly of claim 21, wherein one or more of:
(a) the low coefficient of friction material comprises PTFE or PTFE-containing compounds, graphene or graphene-containing compounds, MoS2 or MoS2-containing compounds, or combinations thereof; or
(b) the thermally conductive material comprises a metal or metal alloy integrated with one or more of the sealing elements, applied about one or more of the seal elements, or combinations thereof, the metal or metal alloy comprising one or more of:
(1) aluminum, aluminum alloy, brass, bronze, silver, silver alloy, copper, copper alloy, steel, steel alloy, or a combination thereof;
(2) a plurality of metal and/or metal alloy fibers, including loose metalized fibers, metal and/or metal alloy flakes, metal and/or metal alloy filaments, a metal and/or metal alloy mesh, metal and/or metal alloy sheet materials including metalized fabrics or ribbons, a woven metal and/or metal alloy mesh, metal and/or metal alloy chips, or combinations thereof.

25. The sealing assembly of claim 21, wherein one of:
(a) the first component or the at least one seal element is substantially integrated or mixed with the thermally conductive material to form a seal element with a thermal conductivity greater than 0.5 W/mK;
(b) the plurality of seal elements comprises at least one lantern ring; at least one lube seal; at least one adaptor ring; at least one pressure ring; and at least one header ring;
(c) the at least one seal element further comprises a heat sink defined along at least a portion thereof;
(d) the at least one seal element comprises a pressure ring or a header ring.

26. A method for enhancing a seal between a first component of a pump and a second component of the pump, the method comprising:
positioning a sealing assembly between a surface of the first component of the pump and a surface of the second component of the pump, the sealing assembly including a seal body having plurality of seal elements, at least one seal element comprising:
(a) a base component including:
(1) one or more of a wear resistant material or a low coefficient of friction material, and
(2) at least one additive component substantially integrated therewith; and
(b) one or more of:
(1) a thermally conductive material having one or more of a thermal conductivity greater than a thermal conductivity of a base material of the at least one seal element, or
(2) a low coefficient of friction material having a coefficient of friction lower than a coefficient of friction of the base material; and
transferring heat, generated by movement of the first component of the pump with respect to the second component of the pump, through the seal body of the sealing assembly to one or more of:
(a) the first component of the pump,
(b) the second component of the pump, or
(c) a fluid passing through the pump,
thereby to reduce a temperature of the seal and extend a service life of the seal.

27. The method of claim 26, wherein one or more of:
(a) the base material comprises an elastomer, thermoplastic polymer, thermosetting polymer, elastomeric polymer, thermosetting plastics, natural rubber, synthetic rubber, nitrile, butadiene rubber, polyether ether ketone (PEEK), fabric reinforced rubber, aramid reinforced rubber, fiber reinforced rubber, fluorocarbon resins, thermoplastic polyurethane (TPU), thermoplastic copolyester (COPE), ethylene propylene diene monomer (EPDM), highly saturated nitrile rubber (HNBR), polytetrafluoroethylene (PTFE), thermoplastic polyurethane (TPU), RESILON, polyurethane, or combinations thereof; or
(b) the at least one additive component comprises a thermally conductive reinforcing fabric including:
about 5% to about 100% carbon fiber;
about 0% to about 95% of secondary fibers comprising aramid fibers, cotton fibers, PET fibers, or combinations thereof; and
about 0% to about 95% of a binder comprising: urethane, elastomers, thermoplastics, rubber, or combinations thereof.

28. The method of claim 26, wherein:
(a) the positioning of the sealing assembly comprises positioning the plurality of seal elements in a stacked arrangement to define the seal body, the positioning of the sealing assembly further comprising positioning one or more of the seal elements of the seal assembly between a stationary component of the pump and one or more of (1) a reciprocating component of the pump or (2) a rotating component of the pump; and
(b) the transferring heat, through the seal body to the first component, to the second component, to a fluid passing through the pump, or a combination thereof, comprises transferring heat from the seal body to one or more of a packing sleeve, a fluid end block, a plunger, a portion of a housing, or combinations thereof.

29. The method of claim 26, wherein the positioning of the sealing assembly comprises one or more of:
(a) positioning at least one lantern ring, at least one pressure ring, and at least one header ring in a stacked arrangement; wherein at least one of the at least one pressure ring and the at least one header ring comprises a heat sink defined along at least a portion thereof; or
(b) positioning the sealing assembly along a plunger bore between a packing sleeve of the pump and a plunger of the pump.

30. The method of claim 26, wherein the first component of the pump comprises a plunger, the method further comprising applying a plunger coating to a surface of the plunger, the plunger coating including a filler material comprising a high thermal conductivity material.
